(19) United States
(12) Patent Application Publication
(10) Pub. No.: US 2016/0288206 A1
(43) Pub. Date: Oct. 6, 2016

(54) POWDER MATERIAL FOR THREE-DIMENSIONAL MODELING, MATERIAL SET FOR THREE-DIMENSIONAL MODELING, DEVICE OF MANUFACTURING THREE-DIMENSIONAL OBJECT, METHOD OF MANUFACTURING THREE-DIMENSIONAL OBJECT, AND THREE-DIMENSIONAL OBJECT

(71) Applicants: Kazumi OHTAKI, Shizuoka (JP); Hitoshi Iwatsuki, Shizuoka (JP); Yasuyuki Yamashita, Shizuoka (JP); Mitsuru Naruse, Shizuoka (JP); Yasuo Suzuki, Shizuoka (JP); Nozomu Tamoto, Shizuoka (JP)

(72) Inventors: Kazumi OHTAKI, Shizuoka (JP); Hitoshi Iwatsuki, Shizuoka (JP); Yasuyuki Yamashita, Shizuoka (JP); Mitsuru Naruse, Shizuoka (JP); Yasuo Suzuki, Shizuoka (JP); Nozomu Tamoto, Shizuoka (JP)

(21) Appl. No.: 15/078,101

(22) Filed: Mar. 23, 2016

(30) Foreign Application Priority Data
Mar. 30, 2015 (JP) 2015-070009

(51) Int. Cl. B22F 1/02; B22F 1/00; B28B 1/00; B22F 3/00

(52) U.S. Cl. CPC B22F 1/02; B22F 3/008; B22F 1/0007; B28B 1/001

(57) ABSTRACT

A powder material for three-dimensional modeling includes a base material and a resin covering the base material, wherein the covering factor by the resin is 15 percent or more and the aspect ratio of the powder material is 0.90 or greater as calculated according to the following relation 1.

Aspect ratio (average)=X1×Y1/100+X2×Y2/100+ . . . +Xn×Yn/100, Relation 1

In the Relation 1, Y1+Y2+ . . . +Yn=100 (percent), Xn represents the aspect ratio (minor axis/major axis), Yn represents an existence ratio (percent) of a particle having an aspect ratio of Xn, and n is 15,000 or greater.

### CROSS-REFERENCE TO RELATED APPLICATIONS

This patent application is based on and claims priority pursuant to 35 U.S.C. §119 to Japanese Patent Application No. 2015-070009 filed on Mar. 30, 2015, in the Japan Patent Office, the entire disclosures of which are hereby incorporated by reference herein.

### BACKGROUND

1. Technical Field

The present invention relates to a powder material for three-dimensional modeling, a material set for three-dimensional modeling, a device of manufacturing a three-dimensional object, a method of manufacturing a three-dimensional object, and a three-dimensional object.

2. Background Art

Demand for manufacturing complex three-dimensional objects is increasing. A conventional method of manufacturing three-dimensional (3D) objects utilizing a mold is too limited to manufacture, for example, complex and fine modeling objects or not suitable for small-lot production because such a mold is expensive. On the other hand, three-dimensional modeling (also referred to as additive manufacturing) of directly manufacturing a three-dimensional object by laminating various materials using form data is introduced as a method suitable to solve these issues.

### SUMMARY

According to the present invention, provided is an improved powder material for three-dimensional modeling which includes a base material and a resin covering the base material, wherein the covering factor by the resin is 15 percent or more and the aspect ratio of the powder material is 0.90 or greater as calculated according to the following relation 1.

Aspect ratio (average)=X1×Y1/100+X2×Y2/100+ . . . +Xn×Yn/100, Relation 1

In the Relation 1, Y1+Y2+ . . . +Yn=100 (percent), Xn represents the aspect ratio (minor axis/major axis), Yn represents an existence ratio (percent) of a particle having an aspect ratio of Xn, and n is 15,000 or greater.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1A is a schematic diagram illustrating an example of the process of supplying a powder material for 3D modeling from a powder storage tank for supplying to a powder storage tank for modeling in the manufacturing process of a three-dimensional object according to an embodiment of the present disclosure;

FIG. 1B is a schematic diagram illustrating an example of the process of forming a powder material layer for 3D modeling having a smooth surface by the powder material layer forming device for 3D modeling in the manufacturing process of a three-dimensional object according to an embodiment of the present disclosure;

FIG. 1C is a schematic diagram illustrating an example of the process of dripping a liquid material for 3D modeling to the powder material layer for 3D modeling of the powder storage tank for 3D modeling by a liquid material supplying device for 3D modeling in the manufacturing process of a three-dimensional object according to an embodiment of the present disclosure;

FIG. 1D is a schematic diagram illustrating an example of a process of elevating the stage of the powder storage tank for supplying and lowering the stage of the powder to control the gap therebetween to obtain a desired layer thickness in the manufacturing process of a three-dimensional object according to an embodiment of the present disclosure;

FIG. 1E is a schematic diagram illustrating an example of the process of, subsequent to the gap control, moving the powder material layer forming device for 3D modeling again from the powder storage tank for supplying to the powder storage tank for modeling to form a new powder material layer for 3D modeling on the powder storage tank for supplying in the manufacturing process of a three-dimensional object according to an embodiment of the present disclosure;

FIG. 1F is a schematic diagram illustrating an example of the process of dripping the liquid material for 3D modeling again to the powder material layer for 3D modeling of the powder storage tank for 3D modeling by the liquid material supplying device for 3D modeling in the manufacturing process of a three-dimensional object according to an embodiment of the present disclosure;

FIG. 2A is a schematic diagram illustrating another example of the process of supplying the powder material for 3D modeling from a powder storage tank for supplying to a powder storage tank for modeling in the manufacturing process of a three-dimensional object according to an embodiment of the present disclosure;

FIG. 2B is a schematic diagram illustrating an example of the process of, after the powder material for 3D modeling is supplied to the powder storage tank for 3D modeling, controlling the gap to obtain a desired layer thickness and moving the powder material layer forming device for 3D modeling to form a powder material layer for 3D modeling on the powder storage tank for 3D modeling in the manufacturing process of a three-dimensional object according to an embodiment of the present disclosure;

FIG. 2C is a schematic diagram illustrating an example of the process of dripping the liquid material for 3D modeling to the powder material layer for 3D modeling of the powder storage tank for 3D modeling by the liquid material supplying device for 3D modeling in the manufacturing process of a three-dimensional object according to an embodiment of the present disclosure;

FIG. 2D is a schematic diagram illustrating an example of the process of lowering the stage of the powder storage tank for 3D modeling to supply the powder material for 3D modeling from the powder storage tank for supplying to the powder storage tank for 3D modeling in the manufacturing process of a three-dimensional object according to an embodiment of the present disclosure;

FIG. 2E is a schematic diagram illustrating an example of the process of, after the powder material for 3D modeling is supplied to the powder storage tank for 3D modeling, controlling the gap to obtain a desired layer thickness and moving the powder material layer forming device for 3D modeling again to form a powder material layer for 3D modeling on the powder storage tank for 3D modeling in the manufacturing process of a three-dimensional object according to an embodiment of the present disclosure;

FIG. 2F is a schematic diagram illustrating an example of the process of dripping the liquid material for 3D modeling again to the powder material layer for 3D modeling of the powder storage tank for 3D modeling by the liquid material supplying device for 3D modeling in the manufacturing process of a three-dimensional object according to an embodiment of the present disclosure;

FIG. 3 is a schematic diagram illustrating an example of the powder storage tank of the device for manufacturing a 3D object according to an embodiment of the present disclosure; and

FIG. 4 is a schematic diagram illustrating area envelope degree of a particle for description.

### DETAILED DESCRIPTION

For example, powder particles coated with a resin are laminated and ink is discharged to the laminated powder particles to manufacture three-dimensional object. Japanese Translation of PCT International Application Publication No. JP-T-2006-521264 discloses a powder material including a particle of metal, ceramic, etc., coated with an adhesive and fine particle material that can be active. Japanese Unexamined Patent Application Publication No. 2005-297325 discloses a method of manufacturing a three-dimensional object by forming a layer of a powder material including a base material coated with a resin, dissolving the resin, and thereafter supplying a solvent to solidify the resin to bind the powder material. Such methods which use powder materials including base materials coated with resins are advantageous in terms that the modeling speed is high, the resins can be relatively uniformly disposed, and inkjet nozzles are almost free of clogging, thereby improving the strength and dimension accuracy of a three-dimensional object.

By using a powder material including a base material coated with a resin, clogging of inkjet nozzles is reduced but the strength varies.

The present disclosure is to provide a powder material for 3D modeling to manufacture a three-dimensional object having a uniform strength while reducing variation of the strength of the three-dimensional object.

As a result of an investigation, the present inventors have found that when a liquid material for three-dimensional modeling is dripped to a layer of a powder material for 3D modeling including a base material coated with a resin and permeates into the layer, sparse or dense of re-disposition of the powder material for 3D modeling occurs. Also, the present inventors have found that such sparse or dense of re-disposition of the powder material for 3D modeling causes reduction of the strength of a 3D object and variation of strength. In addition, when the strength of a 3D object is weak, the form of the 3D object is not maintained until sintering so that a target complex form is not reproduced. The present inventors have come to a thought of reducing the sparse or dense caused by re-disposition of the powder material for 3D modeling to obtain a 3D object and a sintered compact that can maintain a complex form and have a high strength with no local difference.

Powder Material for 3D Modeling

The powder material for 3D modeling of the present disclosure contains a base material covered with a resin and other optional components.

The base material is mainly covered with the resin. However, the coverage film may optionally further contain an inorganic material. The powder material for 3D modeling is suitably used in the material set for 3D modeling of the present disclosure containing a liquid material for 3D modeling, the device for manufacturing a 3D object of the present disclosure, and the method of manufacturing a 3D object of the present disclosure.

Base Material

The base material has no specific limit and can take any form of powder or particle. Examples of the materials therefor are metal, ceramics, carbon, polymer, wood, biocompatible materials, and sand. Of these, metal and ceramic, which can be bearable to sintering are preferable in terms of manufacturing a 3D object having a high level of strength.

The base material is preferably insoluble in water.

“Insoluble in water” means substantially insoluble in water. Substantially insoluble” means that after a material is dipped in a large quantity of water at 25 degrees C. for 24 hours and thereafter sufficiently dried by vacuum drying, etc., the change of the mass of the material is 1 percent by mass or less.

The base material does not preferably conduct reaction with the liquid material for 3D modeling. The reaction includes cross-linking reaction and other chemical reactions such as covalent bonding and ion bonding.

Specific examples of the metal include, but are not limited to, Mg, Al, Ti, V, Cr, Mn, Fe, Co, Ni, Cu, Zn, Y, Zr, Nb, Mo, Pd, Ag, In, Sn, Ta, W, and alloys of these. Of these, stainless (SUS) steel, iron, copper, silver, titanium, zirconium, or alloys of these.

Specific examples of the stainless (SUS) steel include, but are not limited to, SUS304, SUS316, SUS317, SUS329, SUS410, SUS430, SUS440, and SUS630.

Examples of the ceramic are oxides, carbides, nitrides, hydroxides, etc. Specific examples of the oxides include, but are not limited to, silica (SiO₂), alumina (Al₂O₃), zirconia (ZrO₂), and titania (TiO₂).

Specific examples of the carbon include, but are not limited to, graphite, graphene, carbon nanotube, carbon nanohorn, and fullerene.

Examples of the polymer are known resins insoluble in water.

Specific examples of the wood include, but are not limited to, wood chip and cellulose.

Specific examples of the biocompatible materials include, but are not limited to, polylactic acid and calcium phosphate.

These materials can be used alone or in combination.

It is possible to use powder or particles available on market formed of these materials as the base material in the present disclosure.

Specific examples of such products include, but are not limited to, SUS316L (PSS316L, manufactured by Sanyo Special Steel Co., Ltd.), SiO₂ (EXCELICA SE-15K, manufactured by Tokuyama Corporation), Al₂O₃ (TAIMICRON™-5D, manufactured by TAIMEI CHEMICALS Co., Ltd.), and ZrO₂ (TZ-B53, manufactured by TOSOH CORPORATION).

The base material may be subject to known surface (reforming) treatment in order to improve affinity with the resin.

The volume average particle diameter of the base particle has no particular limit. For example, the base material preferably has a volume average particle diameter of from 2 μm to 100 μm and more preferably from 10 μm to 50

When the volume average particle diameter is in the range of from 2 μm to 100 μm, the manufacturing efficiency of 3D objects is excellent and handling property is also good so that the strength of the obtained 3D objects and sintered compacts are improved.

The particle size distribution of the base material is not particularly limited and can be suitably selected to a particular application. It is preferable to have a sharper particle size distribution.

The volume average particle diameter of the base material can be manufactured by a known particle diameter measuring device. A specific example thereof is a particle size distribution measuring device (Microtrac MT3000II series, manufactured by MicrotracBEL Corp.).

The base material has no particular limit and can be manufactured by a known method. As the method of manufacturing a base material of powder or particle, for example, a pulverization method of pulverizing a solid by compression, impact, friction, etc., an atomizing method of spraying a molten metal to obtain quenched powder, a precipitation method of precipitating a component dissolved in a liquid, and a gas-phase reaction method of gasification for crystallization.

The method of manufacturing the base material has no particular limit. A preferred example is the atomizing method to obtain spherical particles with less variation of the particle diameter. The atomizing method has no specific limit. Specific examples thereof include, but are not limited to, water atomization methods, gas atomization methods, centrifugal atomization, and plasma atomization.

Resin

As the resin, it is suitable to use a cross-linkable resin the liquid material for 3D modeling can dissolve.

In the present disclosure, the dissolution property of the resin means that, for example, when 1 g of the resin described above is mixed and stirred in 100 g of a solvent constituting a liquid material for 3D modeling at 30 degrees C., 90 percent by mass or more of the resin is dissolved therein.

In addition, as the resin, 4 percent by mass (w/w percent) solution of the resin preferably has a viscosity of 40 mPa·s or less at 20 degrees C., more preferably from 1 mPa·s to 35 mPa·s, and particularly preferably from 5 mPa·s o 30 mPa·s.

When the viscosity is 40 mPa·s or less, the strength of the cured object (3D object) of the powder material (layer) for 3D modeling formed by applying the liquid material for 3D modeling to the powder material for 3D modeling is improved, which makes it free from problems such as losing shape during processing such as sintering or handling conducted after the layer forming. In addition, the dimension accuracy of a cured object (3D object) of the powder material (layer) for 3D modeling formed by applying the liquid material for 3D modeling to the powder material for 3D modeling tends to be improved.

The viscosity can be measured, for example, according to the measuring method described in JTS K7117.

The resin has no specific limit and is suitably selected to a particular application. Preferably, the resin is water-soluble in terms of handling property and burden on environment. For example, water-soluble resins and water-soluble prepolymers are suitable. For the powder material for 3D modeling using such a water-soluble resin, an aqueous medium can be used as the solvent of the liquid material for 3D modeling. In addition, when the powder material is abandoned or recycled, it is easy to separate the base material from the resin by water treatment.

Specific examples of the water-soluble resins include, but are not limited to, polyvinylalcohol resins, polyacrylic acid resins, cellulose resins, starch, gelatin, vinyl resins, amide resins, imide resins, acrylic resins, and polyethylene glycol. If these are water-soluble, homopolymers (monopolymers), heteropolymers (copolymers), modified resins, or salts are allowed. Moreover, known functional groups can be introduced into these.

Accordingly, for example, in the case of a polyvinyl alcohol resin, polyvinyl alcohol is suitable and modified polyvinyl alcohol (modified by an acetoacetyl group, an acetyl group, or silicone) are also suitable. In addition, butanediol vinyl alcohol copolymers are also an optional. Moreover, in the case of a polyacrylic acid resin, polyacrylic acid and salts such as sodium polyacrylate are suitable.

In addition, in the case of a cellulose resin, cellulose is suitable and carboxymethyl cellulose (CMC) is also suitable. Moreover, in the case of an acrylic resin, polyacrylic resin and a copolymer of acrylic acid and maleic anhydride are suitable. In the case of a water-soluble prepolymer, for example, an adhesive water-soluble isocyanate prepolymer contained in a water stop is suitable.

In addition to the water-soluble resin, the following resins are suitable as the resin: acrylic acid resins, maleic acid resins, silicone, butyral, polyester, polyvinyl acetate, copolymers of vinyl chloride and vinyl acetate, polyethylene, polypropylene, polyacetal, copolymers of ethylene and (meth)acrylic acid, copolymers of α-olefin and maleic anhydride, esterified compounds of copolymers of α-olefin and maleic anhydride, polystyrene, poly(meth)acrylates, copolymers of α-olefin, maleic anhydride, and monomers containing a vinyl group, copolymers of styrene and maleic anhydride, copolymers of styrene and (meth)acrylate, polyamide, epoxy resins, xylene resins, ketone resins, petroleum resins, rosin or derivatives thereof, coumarone-indene resins, terpene resins, polyurethane resins, synthesized rubber such as styrene/butadiene rubber, polyvinyl butyral, nitrile rubber, acrylic rubber, and ethylene/propylene rubber, and nitrocellulose.

In the present disclosure, of these resins, resins having cross-linkable functional groups are preferable. Such cross-linkable functional groups have no specific limit. Specific examples thereof include, but are not limited to, hydroxyl group, carboxyl group, amide group, phosphoric acid group, thiol group, acetoacetyl group, and ether bond.

The resin having such a cross-linkable functional group is preferable in terms that the resin is easily cross-linked to form a cured material (3D object). Of these, polyvinyl alcohol resins having an average degree of polymerization of from 400 to 1,100.

The resin can be used alone or in combination. In addition, it is suitable to synthesize such a resin and use products available on market.

Specific examples of the products available on market include, but are not limited to, polyvinyl alcohol (PVA-205C, PVA-220C, manufactured by KURARAY CO., LTD.), completely-saponified polyvinyl alcohol (KL105, manufactured by KURARAY CO., LTD.), polyacrylic acids (JURYMER® AC-10, manufactured by TOAGOSEI CO LTD.), sodium polyacrylate (JURYMER® AC-103P, manufactured by TOAGOSEI CO., LTD.), acetoacetyl group-modified polyvinyl alcohol (Gohsenx Z-300, Gohsenx Z-100, Gohsenx Z-200, Gohsenx Z-205, Gohsenx Z-210, and Gohsenx Z-220, manufactured by The Nippon Synthetic Chemical Industry Co., Ltd.), copolymers of carboxy group-modified polyvinyl alcohol (Gohsenx T-330, Gohsenx T-350, and Gohsenx T-330T, manufactured by The Nippon Synthetic Chemical Industry Co, Ltd.), diacetone acrylamide-modified polyvinyl alcohol (DF-05, manufactured by JAPAN VAM & POVAL CO., LTD.), butanediol vinyl alcohol copolymer (Nichigo G-Polymer OKS-8041, manufactured by The Nippon Synthetic Chemical Industry Co., Ltd.), carboxymethyl cellulose sodium (CELLOGEN 5A, CELLOGEN 6A, manufactured by DKS Co. Ltd.), starch (Histard PSS-5, manufactured by Sanwa Starch Co., Ltd.), and gelatin (beMatrix®, manufactured by Nitta Gelatin Inc.).

The coverage film of the base material by the resin preferably has an average thickness of from 5 nm to 1,000 nm, more preferably from 5 nm to 500 nm, furthermore preferably from 50 nm to 300 nm, and particularly preferably from 100 nm to 200 nm.

When coverage film of the base material has an average coverage thickness of 5 nm or greater, the cured object formed of the powder material (layer) for 3D modeling formed by applying the liquid material to the powder material for 3D modeling has sufficient strength and is free of problems such as losing shape during handling such as sintering after curing. When the average thickness is 1,000 nm or less, the dimension accuracy of the cured object (3D object) formed of the powder material (layer) for 3D modeling formed by applying the liquid material to the powder material for 3D modeling is improved.

The coverage thickness can be obtained by, for example, embedding the powder material for 3D modeling in an acrylic resin, etc., exposing the surface of the base material by etching, etc., and thereafter measuring the thickness with a scanning tunneling microscope (STM), an atomic force microscope (AFM), or a scanning electron microscope (SEM).

The coverage factor (area ratio) of the surface of the base material by the resin is 15 percent or more, preferably 50 percent or more, and more preferably 80 percent or more.

When the coverage factor is 15 percent or more, the strength of the cured object (3D object) formed of the powder material (layer) for 3D modeling formed by applying the liquid material to the powder material for 3D modeling is sufficient, which makes it free from problems such as losing shape during processing such as sintering conducted after forming the layer.

In addition, the dimension accuracy of the cured object (3D object) formed of the powder material (layer) for 3D modeling formed by applying the liquid material to the powder material for 3D modeling is improved.

The coverage factor is obtained by, for example, observing a photograph of the powder material for 3D modeling and calculating the average of the area ratio (percent) of the portion covered with the resin to all the area of the surface of the base material (particle) about the powder material for 3D modeling photo-shot in the two-dimensional photograph. The average is determined as the coverage factor. In addition, the coverage factor can be obtained by measuring the portion covered with the resin by element mapping according to energy dispersive X-ray spectrometry (such as SEM-EDS)

The amount of attachment of the resin to the powder material for 3D modeling is preferably from 0.5 percent by mass or more and more preferably from 0.7 percent by mass or more in order to secure the strength bearable to handling of a manufactured object.

The amount of attachment of the resin is, for example, obtained based on mass reduction ratio by heating to 400 degrees C. using a thermogravimetric analyzer (TGA-50, manufactured by Shimadzu Corporation).

Other Components

The other optional components are not particularly limited and can be selected to a suitable application. Examples thereof are a filler, a leveling agent, and a sintering helping agent. Mainly, the filler is attached to the surface of the powder material for 3D modeling and the voids between the powder material for 3D modeling is filled in with the filler. For example, such fillers improves fluidity of the powder material for 3D modeling and increasing contact points between the powder material for 3D modeling, thereby reducing voids. This may help improving the strength and dimension accuracy of a 3D object. The leveling agent is suitable to control wetting property of the surface of the powder material for 3D modeling. For example, the leveling agent helps increasing permeation of the liquid material for 3D modeling to the powder material layer for 3D modeling, enhancing the strength of a 3D object, and speeding up the enhancement of the strength, and stably maintains the form. The sintering helping agent is suitable to increase the efficiency of sintering when sintering an obtained 3D object. For example, the sintering helping agent improves the strength of a 3D object, lowers the sintering temperature, and makes the sintering time short.

Method of Manufacturing Powder Material for 3D Modeling

The method of manufacturing the powder material for 3D modeling has no particular limit. For example, a method of covering the base material with the resin according to a known covering method is suitable.

Method of Covering with Resin

The method of covering the base material with the resin is not particularly limited.

The base particle can be covered by a known method. For example, a tumbling fluidizing method, a spray drying method, a stirring and mixing method, a dipping method, a kneader coating method, etc. are suitable. Of these, the tumbling fluidizing method is preferable in terms of the covering factor by the resin and uniformity in covering thickness.

In the tumbling fluidizing method, a heated wind is sent from below to whirl a powder material in the air to form a flowable layer and a liquid containing a resin is sprayed to the layer to coat the particle with the liquid.

The particle is coated by using a tumbling fluidizing coating device available on market. However, if the resin is easily thermally attached or dissolved in solvents, the flowable layer becomes unstable, leading to excessive agglomeration, due to which coating cannot continue at worst.

Disintegration Treatment

The powder material for 3D modeling covered with the resin by the covering method may adhere to each other during coating, causing the powder material to agglomerate. The agglomeration body worsens smoothness of the surface of the recoated layer during recoating and inhibits fine filling, inviting sparse and dense between the recoated layers. As a consequence, strength between the layers is weakened so that peeling of the layer tends to occur. Accordingly, it is preferable to disintegrate such agglomeration bodies.

As such disintegration, for example, a collision disintegration method (using a jet mill, etc.) using high pressure air, a bead disintegration method (using a bead mill, etc.) using SUS balls or ceramic balls, a disintegration method (using a pin mill) using a wing or pin rotating at high speed, etc. are suitable. Of these, the collision disintegration method using high pressure air is preferable because, during disintegration, the form of the powder material is maintained and the resin covering the powder material is not easily removed. However, if the strength of the powder material against impact is low, care should be taken to determine the disintegration conditions to avoid disintegration of the powder material itself.

Properties of Powder Material for 3D Modeling

Aspect Ratio

The aspect ratio of the powder material for 3D modeling is 0.90 or more.

When the aspect ratio is 0.90 or more, the strength of the obtained 3D object does not vary depending on part but is uniform.

Although the detailed mechanism of the effect of setting the aspect ratio is not clear, when the aspect ratio is 0.90 or more, voids between the powder material for 3D modeling are uniform. Therefore, when the liquid material for 3D modeling is dripped, the liquid uniformly permeates into the powder material so that the liquid cross-linking force is evenly applied to the powder material and uniformly shrinks. Thus, the obtained 3D object has uniform strength irrespective of area of the 3D object.

The aspect ratio can be measured by a known particle form measuring device such as Morphologi G3-SE, manufactured by Spectris Co., Ltd.).

The measuring condition has no particular limit. For example, the measuring is conducted under the conditions of: dispersion pressure: 4 bar, compressed air applying time: 10 ms, leave to rest time: 60 seconds, number of measuring particles: 50,000, and filtering by degree of area envelope. Only particles considered as primary particles are subject to analysis.

The degree of area envelope means a value obtained by dividing the area 17A of the particle 17 with the total area (17A+17B) of the entire particle enclosed by the convex envelope as illustrated in FIG. 4. The degree of area envelope is represented by the value of from 0 to 1 as shown in the following relation 2 and indicates how jagged the particle is. Filtering is conducted by degree of area envelop >0.99>100 pixels and the number of measuring particles after filtering is preferably 15,000 or greater and more preferably 20,000 or greater.

Degree of area envelope of particle={area 17A of particle}/{area(17A+17B) of entire particle} Relation 2

The aspect ratio (average) is obtained by obtaining each aspect ratio (minor axis/major axis) of each particle for use in analysis and thereafter weighing with how much the particle having each aspect ratio exists in the analyzed entire particles and calculated by the following Relation 1:

Aspect ratio (average value)=X1×Y1/100+X2×Y2/100+ . . . +Xn×Yn/100, Relation 1

In the Relation 1, Y1+Y2+ . . . +Yn=100 (percent), Xn represents the aspect ratio (minor axis/major axis), Yn represents an existence ratio (percent) of a particle having an aspect ratio of Xn, and n is 15,000 or greater.

Volume Average Particle Diameter and Particle Size Distribution

The volume average particle diameter of the powder material for 3D modeling is not particularly limited. For example, the volume average particle diameter is preferably from 2 μm to 100 μm and more preferably from 10 μm to 50 μm.

When the volume average particle diameter is 2 μm or more, control of the powder material is good during recoating, thereby preventing attachment to the recoater or stir-up of the powder material. Consequently, smoothness of the recoat layer is improved. When the volume average particle diameter is 100 μm or less, a 3D object is sintered well so that the density of the sintered compact is high, which secures sufficient strength.

The particle size distribution of the powder material for 3D modeling has no particular limit. To improve uniformity of the strength of a 3D object, the powder material preferably has a ratio (D90/D10) of a volume-basis cumulative 90 percent diameter (D90) to a volume-basis cumulative 10 percent diameter (D10) of 3.0 or less as measured by a laser scattering particle size distribution measurement method.

When the particle size distribution is sharp, the ratio (D90/D10) approaches to 1.

The volume average particle diameter and the powder material for 3D modeling of the powder material for 3D modeling can be measured by a known particle size measuring device, such as Microtrac MT3000II series (manufactured by MicrotracBEL Corp.).

Form and Circularity

The form and circularity of the powder material for 3D modeling have no particular limit. Preferably, the form is a sphere and the circularity is high (closer to 1). In that case, the powder material for 3D modeling is closest packed and the void of the obtained 3D object and the sintered compact can be reduced, which may contribute to enhancement of strength. Circularity can be measured by using a known circularity measuring device such as a flow-type particle image analyzer (FPIA-3000, manufactured by Malvern Instruments Ltd.).

Flowability

Flowability (fluidity) of the powder material for 3D modeling is not particularly limited and can be suitably determined to a particular application. The flowability of the powder material for 3D modeling can be measured by a known method. For example, methods using a repose angle, degree of compression, flowing speed, a shearing cell test, etc. are suitable. The repose angle is generally used and formed by the horizontal plane and the slope of a pile (mountain) of powder stably held without voluntary collapse when the powder is dropped from a certain height. The repose angle can be measured by, for example, a powder property measuring device such as powder tester PT-N type (manufactured by Hosokawa Micron Corporation).

The repose angle of the powder material for 3D modeling of the present disclosure is preferably 55 degrees or less, more preferably 40 degrees or less, and furthermore preferably 35 degrees or less.

The powder material for 3D modeling of the present disclosure can be applied to simple and efficient manufacturing of various modeled objects and also particularly suitably applied to the material set for 3D modeling of the present disclosure, the method of manufacturing a 3D object of the present disclosure, and the device for manufacturing a 3D object of the present disclosure described later.

Material Set for 3D Modeling

The material set for 3D modeling of the present disclosure contains the powder material for 3D modeling of the present disclosure, a liquid material for 3D modeling, and other optional components.

For example, in the present disclosure, a layer of the powder material for 3D modeling is formed and thereafter the liquid material for 3D modeling is applied to the layer to dissolve or swell the covering resin formed on the surface of the powder material for 3D modeling by the liquid component contained in the liquid material for 3D modeling, thereby attaching the powder material for 3D modeling to the adjacent powder material for 3D modeling. This operation is repeated followed by drying to obtain a 3D object. The powder material for 3D modeling and the liquid material for 3D modeling used in this case are referred to as the material set for 3D modeling in the present disclosure.

In addition, for example, the material set for 3D modeling of the present disclosure can be obtained by simply mixing the powder material for 3D modeling and the liquid material for 3D modeling with a desired ratio and pouring the thus-obtained slurry into a mold or shaping a 3D object. The material set includes such slurry. That is, the material set for 3D modeling of the present disclosure includes all the combinations of the present disclosure and the liquid material for 3D modeling irrespective of the method of manufacturing a 3D object.

Liquid Set for 3D Modeling

The liquid material for 3D modeling contains a liquid component to dissolve the resin contained in the powder material for 3D modeling, preferably a cross-linking agent, and other optional components.

The liquid material for 3D modeling is used to cure the powder material for 3D modeling. “To cure” means the state in which the base materials are attached to each other or agglomerate via the covering resin. The powder material for 3D modeling can constantly hold a 3D form by this curing.

When the liquid material for 3D modeling is applied to the resin contained in the powder material for 3D modeling, the resin is dissolved by the liquid component contained in the liquid material for 3D modeling and preferably cross-links by the working of the cross-linking agent contained in the liquid material for 3D modeling.

Liquid Component

The liquid material for 3D modeling takes a liquid form at room temperature, meaning that the liquid material contains a liquid component.

The liquid component has no particular limit as long as the liquid component dissolves the resin contained in the powder material for 3D modeling. Preferably, water and water-soluble solvents are suitably used. In particular, water is used as the main component. The solubility of the resin increases, which makes it possible to manufacture a 3D object having a high level of strength. The ratio of water in the total content of the liquid material for 3D modeling is preferably from 40 percent by mass to 85 percent by mass and more preferably from 50 percent by mass to 80 percent by mass.

When the ratio of water is from 40 percent by mass to 85 percent by mass, the solubility of the resin of the powder material for 3D modeling is good and the strength of the thus-obtained 3D object can be maintained. Also, the inkjet nozzle is kept not dried, thereby preventing clogging or non-discharging of nozzles.

The water-soluble solvent is suitable to enhance water retention and discharging stability in particular when the liquid material for 3D modeling is discharged by using inkjet nozzles. If these are degraded, the nozzle becomes dry, resulting in unstable discharging or clogging. This leads to deterioration of the strength and dimension accuracy of a 3D object. Mostly these water-soluble solvents have higher viscosity and boiling points than water and serve as humectants, drying inhibitors, and viscosity adjusters for the powder material for 3D modeling.

Water-Soluble Solvent

The water-soluble solvent has no particular limit as long as the solvent is a water-soluble liquid material. Specific examples of the organic solvent include, but are not limited to, ethanol, 1,2,6-hexane triol, 1,2-butane diol, 1,2-hexanediol, 1,2-pentanediol, 1,3-diemthyl-2-imidazolidinone, 1,3-butane diol, 1,3-propane diol, 1,4-butane diol, 1,5-pentane diol, 1,6-hexane diol, 2,2-dimethyl-1,3-propane diol, 2,3-butane diol, 2,4-pentane diol, 2,5-hexane diol, 2-ethyl-1,3-hexane diol, 2-pyrolidone, 2-methyl-1,3-propane diol, 2-methyl-2,4-pentane diol, 3-methyl-1,3-butane diol, 3-methyl-1,3-hexane diol, N-methyl-2-pyrolidone, N-methyl pyrrolidinone, β-buthoxy-N,N-dimethylpropione amide, β-methoxy-N,N-dimethyl propione amide, γ-butylolactone, δ-caprolactam, ethylene glycol, ethylene glycol-n-butyl ether, ethylene glycol-n-propylether, ethylene glycol phenyl ether, ethylene glycol mono-2-ethylhexyl ether, ethylene glycol monoethyl ether, glycerin, diethylene glycol, diethylene glycol-n-hexyl ether, di ethylene glycol methyl ether, di ethylene glycol monoethyl ether, dietheylene glycol monobutyl ether, diethylene glycol monomethyl ether, diglycerin, dipropylene glycol, dipropylene glycol, dipropylene glycol-n-propylether, dipropylene glycol monomethylether, dimethylsulfoxide, sulfolane, thiodiglycol, tetraethylene glycol, triethylene glycol, triethylene glycol ethylether, triethylene glycol dimethylether, triethylene glycol monobutylether, triethylene glycol methylether, tripropylene glycol, tripropylene glycol-n-propylether, tripropylene glycol methylether, trimethylol ethane, tirmethylol propane, propylpropylene diglycol, propylene glycol, propylene glycol-n-butylether, propylene glycol-t-butylether, propyleneglycol phenylether, propylene glycol monoethylether, hexylene glycol, polyethylene glycol, polypropylene glycol, aliphatic hydrocarbons, ketone-based solvents such as methylethylketone, ester-based solvents such as ethylacetate, and ether-based solvents such as glycol ether. These can be used alone or in combination.

The content of the water-soluble solvent is preferably from 5 percent by mass to 60 percent by mass, more preferably from 10 percent by mass to 50 percent by mass, and further more preferably from 15 percent by mass to 40 percent by mass to the total content of the liquid material for 3D modeling in light of discharging stability, solubility of resin, drying property of a 3D object, etc.

Cross-Linking Agent

The cross-linking agent is suitable to enhance the strength of a thus-obtained 3D object more by cross-linking with the resin covering the surface of the base material of the powder material for 3D modeling.

Such cross-linking agents are not particularly limited as long as the agent conducts cross-linking reaction with the resin. Examples are metal salts, metal complexes, organic zirconium compounds, organic titanium compounds, and chelating agents. Metal compounds including a metal element are preferable.

Specific examples of the organic zirconium compound include, but are not limited to, zirconium oxychloride, ammonium zirconium carbonate, and ammonium zirconium lactate.

Specific examples of the organic titanium compounds include, but are not limited to, titanium acylate and titanium alkoxide.

These can be used alone or in combination.

Furthermore, as the metal compound, compounds that ionize cation metal having di- or higher valent in water are preferable. Specific examples of the metal compounds include, but are not limited to, zirconium oxychloride octahydrate (quadrivalent), aluminum hydroxide (trivalent), magnesium hydroxide (divalent), titanium lactate ammonium salt (quadrivalent), aluminum subacetate (trivalent), ammonium salt of zirconium carbonate (quadrivalent), titanium triethanol aminate (quadrivalent), glyoxyl acid salts, and zirconium lactate ammonium salts. Of these, to obtain excellent strength of a thus-obtained 3D object, zirconium compounds are preferable and ammonium zirconium carbonate is particularly preferable.

In addition, these are available on market. Specific examples of such products include, but are not limited to, zirconium oxychloride octahydrate (acid zirconium chloride, manufactured by DAIICHI KIGEN SO KAGAKU KOGYO CO., LTD.), aluminum hydroxide (manufactured by Wako Pure Chemical Industries, Ltd.), magnesium hydroxide (manufactured by Wako Pure Chemical Industries, Ltd.), titanium lactate ammonium salts (Orgatix TC-300, manufactured by Matsumoto Fine Chemical Co. Ltd.), zirconium lactate ammonium salts (Orgatix ZC 300, manufactured by Matsumoto Fine Chemical Co. Ltd.), basic aluminum lactate (manufactured by Wako Pure Chemical Industries, Ltd.), bisvinyl sulfone compound (VS-B (K-FJ-C), manufactured by FUJIFINE Chemical CORPORATION), carboxylic acid zirconium ammonium salt (Zircosol AC-20, manufactured by DAIICHI KIGENSO KAGAKU KOGYO CO., LTD.), titanium tri ethanol aminate (Orgatix TC-400, manufactured by Matsumoto Fine Chemical Co. Ltd.), glyoxyl acid salt (Sagelink SPM-01, manufactured by The Nippon Synthetic Chemical Industry Co., Ltd.), and adipic acid dihydrazide (manufactured by Otsuka Chemical Co., Ltd.).

“Cross-linking agent” in the present disclosure is a compound having a portion cross-linkable with a functional group of a target (resin) of cross-linking and constitutes the bond portion of the cross-linking bond between the targets of cross-linking. Therefore, “cross-linking agent” is clearly distinguished from so-called “initiator” like peroxides (organic peroxides) and reducing agents, which is self-decomposed upon application of heat or light, produces free radicals, which are added to unsaturated monomers to open double-bonds, and conducts next radical reaction. The initiator repeats this process to promote polymerization, and extracts a hydrogen bound to a carbon in a saturated compound to produce other radicals for re-bond to form cross-linking between the saturated compounds. That is, the initiator itself is not one of the constituents of the cross-linked portion but just initiates and promotes radical reaction.

In addition, the content of the cross-linking agent in the liquid material for 3D modeling is not particularly limited. Preferably, the content is from 0.1 percent by mass to 50 percent by mass and more preferably from 0.5 percent by mass to 30 percent by mass to the resin in the powder material for 3D modeling.

When the content is from 0.1 percent by mass to 50 percent by mass, the liquid material is not thickened or gelated and the strength of thus-obtained 3D object is enhanced.

Other Components

The other components of the liquid material for 3D modeling are, for example, known materials such as surfactants, humectants, drying inhibitors, viscosity adjusters, permeating agent, defoaming agents, pH controlling agents, preservatives and fungicides, colorants, preserving agents, stabilizing agents. These can be added without no particular limit. Of these, surfactants are preferable.

The surfactant is mainly used to control the surface tension, wetting property, and permeability of the liquid material for 3D modeling to the powder material for 3D modeling.

The content of the surfactant to the liquid material for 3D modeling is preferably from 0.01 percent by mass to 10 percent by mass, more preferably from 0.1 percent by mass to 5 percent by mass, and furthermore preferably from 0.5 percent by mass to 3 percent by mass.

When the total content of the surfactant is less than this range, permeability of the liquid material for 3D modeling to the powder material for 3D modeling deteriorates and the strength of a 3D object may deteriorate. To the contrary, when the total content of the surfactant is greater than this range, permeability of the liquid material for 3D modeling to the powder material for 3D modeling is not appropriately controlled so that the liquid material easily oozes outside a desired area, thereby degrading the dimension accuracy of a thus-obtained 3D object.

The method of preparing the liquid material for 3D modeling is not particularly limited and can be selected to a particular application. For example, a method of adding the other optional components to water or the water-soluble solvent followed by mixing and stirring is suitable.

Method of Manufacturing 3D Object

Known methods can be used as the method of manufacturing a 3D object of the present disclosure. For example, the following method can be used. That is, in this manufacturing method, a layer of the powder material layer for 3D modeling is formed in the step of forming a powder material layer for 3D modeling. The powder material for 3D modeling is supplied to the layer in the step of supplying the liquid material for 3D modeling. These steps are repeated and other optional steps such as drying to manufacture a 3D object. The method of manufacturing a 3D object of the present disclosure can be any method including known methods capable of manufacturing a 3D object using the material set for 3D modeling of the present disclosure.

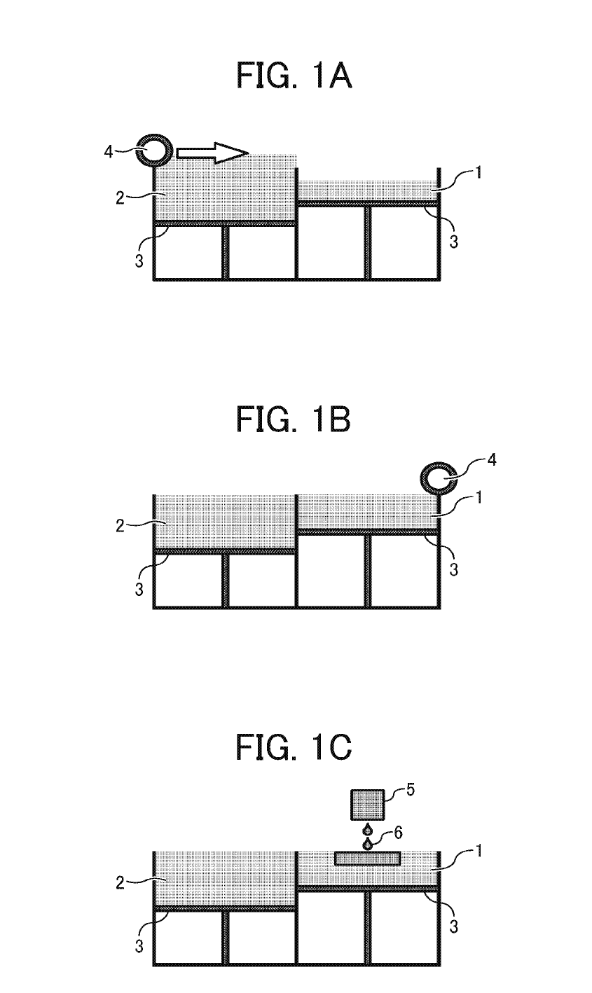

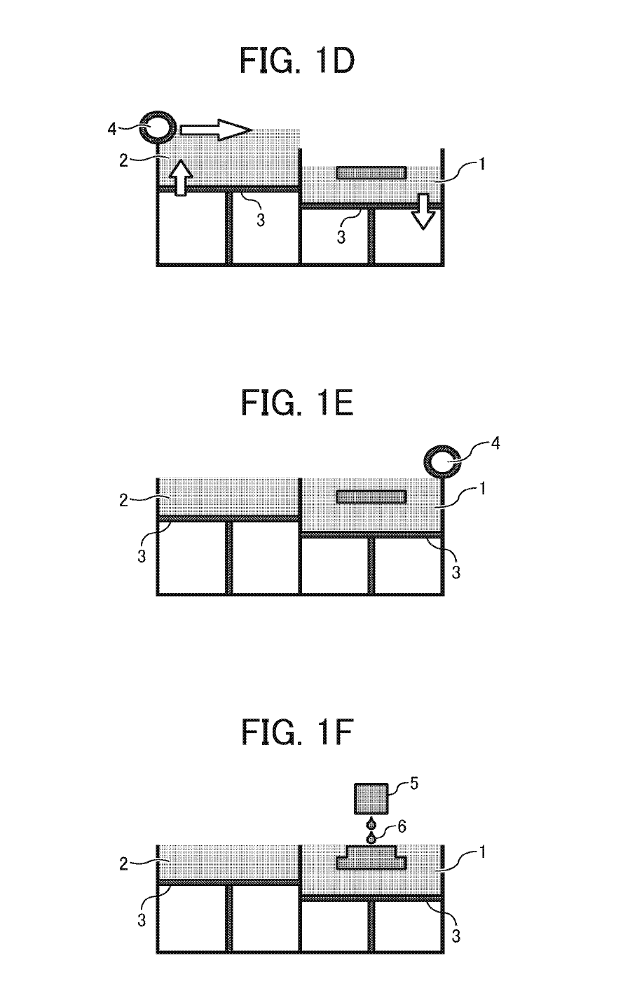

FIGS. 1A to 1F are schematic diagrams illustrating an example of the process of manufacturing a 3D object using the material set for 3D modeling of the present disclosure. The device for manufacturing a 3D object illustrated in FIGS. 1A to 1F includes a powder storage tank 1 for 3D modeling and a powder storage tank 2 for supplying (applying). Each of these powder storage tanks 1 and 2 has a stage 3 movable up and down and places the powder material for 3D modeling of the present disclosure on the stage 3 to form a layer formed of the powder material for 3D modeling.

A liquid material supplying (applying) device 5 for 3D modeling is disposed over the powder storage tank 1 for 3D modeling to discharge a liquid material 6 for 3D modeling toward the powder material for 3D modeling in the powder storage tank 1. Furthermore, the device for manufacturing a 3D object has a powder material layer forming device 4 (hereinafter also referred to as recoater) for 3D modeling capable of supplying (applying) the powder material for 3D modeling from the powder storage tank 2 for 3D modeling to the powder storage tank 1 for 3D modeling and smoothing the surface of the powder material (layer) for 3D modeling in the powder storage tank 1 for 3D modeling.

FIGS. 1A and 1B are diagrams illustrating the step of supplying the powder material for 3D modeling from the powder storage tank 2 for supplying to the powder storage tank 1 for 3D modeling and the step of forming the powder material layer for 3D modeling having a smooth surface. Each stage 3 of the powder storage tank 1 for 3D modeling and the powder storage tank 2 for supplying is controlled to adjust the gap therebetween to obtain a desired thickness and moving the powder material layer forming device 4 for 3D modeling from the powder storage tank 2 for supplying to the powder storage tank 1 for 3D modeling, so that the powder material layer for 3D modeling is formed in the powder storage tank 1 for 3D modeling.

FIG. 1C is a schematic diagram illustrating an example of the process of dripping the liquid material 6 for 3D modeling to the powder material layer for 3D modeling in the powder storage tank 1 for 3D modeling by the liquid material supplying device 5 for 3D modeling. At this point in time, the position where the liquid material 6 for 3D modeling is dripped on the powder material layer for 3D modeling is determined by two-dimensional image data (slice data) obtained by slicing the 3D object into multiple plane layers.

In FIGS. 1D and 1E, the stage 3 of the powder storage tank 2 for supplying is elevated while the stage 3 of the powder storage tank 1 for 3D modeling is lowered to control the gap to obtain a desired thickness. Also, the powder material layer forming device 4 for 3D modeling is moved again from the powder storage tank 2 for supplying to the powder storage tank 1 for 3D modeling, so that a new powder material layer for 3D modeling is formed in the powder storage tank 1 for 3D modeling.

FIG. 1F is a schematic diagram illustrating an example of the process of dripping the liquid material 6 for 3D modeling to the powder material layer for 3D modeling in the powder storage tank 1 for 3D modeling by the liquid material supplying device 5 for 3D modeling.

These series of steps are repeated followed by optional drying and removing the powder material for 3D modeling not attached to the liquid material for 3D modeling to obtain a 3D object.

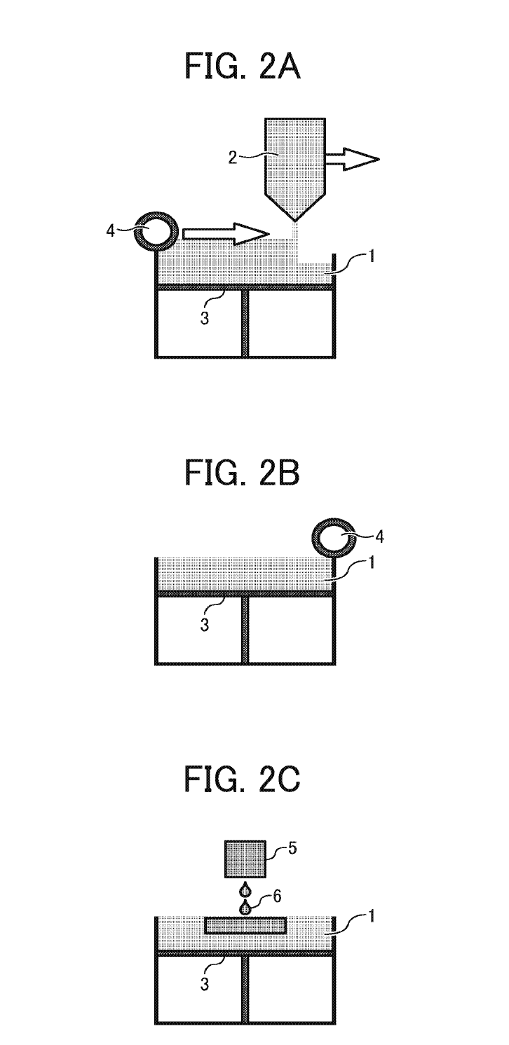

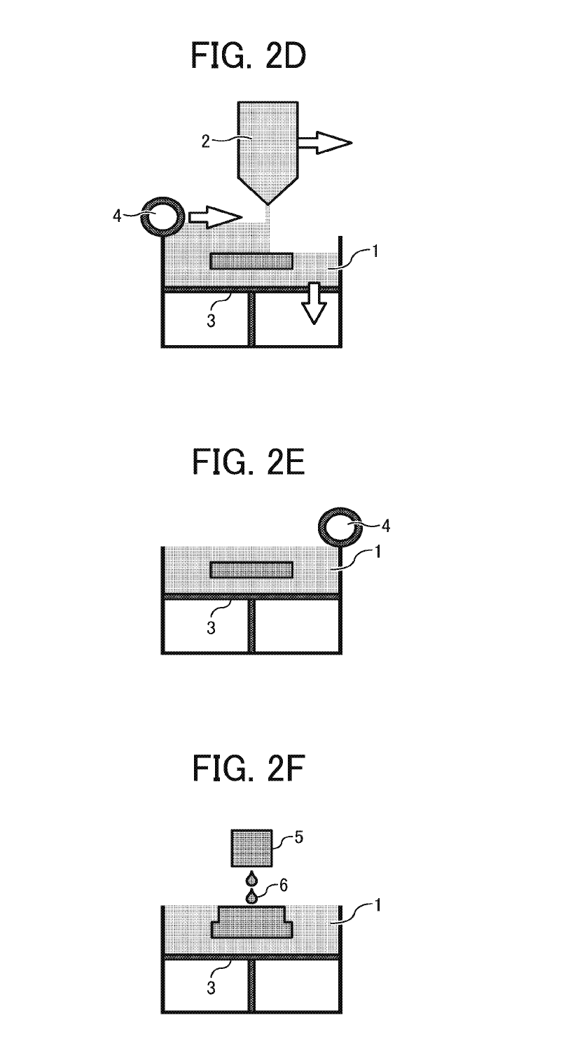

FIGS. 2A to 2F are schematic diagrams illustrating another example of the process of manufacturing a 3D object using the material set for 3D modeling of the present disclosure. The device for manufacturing a 3D object illustrated in FIGS. 2A to 2F operates on the same principle as that illustrated in FIGS. 1A to 1F. However, both have different supplying mechanisms.

FIGS. 2A and 2B are diagrams illustrating the step of supplying the powder material for 3D modeling from the powder storage tank 2 for supplying to the powder storage tank 2 for 3D modeling and the step of forming the powder material layer for 3D modeling having a smooth surface. After the powder material for 3D modeling is supplied to the powder storage tank 1 for 3D modeling, the gap is controlled to obtain a desired layer thickness and the powder material layer forming device 4 for 3D modeling is moved to form a powder material layer for 3D modeling on the powder storage tank 1 for 3D modeling.

FIG. 2C is a schematic diagram illustrating the process of dripping the liquid material 6 for 3D modeling to the powder material layer for 3D modeling in the powder storage tank 1 for 3D modeling by the liquid material supplying device 5 for 3D modeling. At this point in time, the position where the liquid material 6 for 3D modeling is dripped on the powder material layer for 3D modeling is determined by two-dimensional image data (slice data) obtained by slicing the 3D object into multiple plane layers.

In FIGS. 2D and 2E, the stage 3 of the powder storage tank 1 for 3D modeling is lowered to supply the powder material for 3D modeling from the powder storage tank 2 for supplying to the powder storage tank 1 for 3D modeling and the gap is controlled to obtain a desired thickness. Also, the powder material layer forming device 4 for 3D modeling is moved again, so that a new powder material layer for 3D modeling is formed in the powder storage tank 1 for 3D modeling.

FIG. 2F is a schematic diagram illustrating an example of the process of dripping the liquid material 6 for 3D modeling to the powder material layer for 3D modeling again in the powder storage tank 1 for 3D modeling by the liquid material supplying device 5 for 3D modeling.

These series of steps are repeated followed by optional drying and removing the powder material for 3D modeling not attached to the liquid material for 3D modeling to obtain a 3D object.

The device for manufacturing a 3D object illustrated in FIGS. 2A to 2F is advantageous in terms of compacting the size. However, these are just examples of the processes of manufacturing a 3D object and the present disclosure is not limited thereto.

Three-Dimensional (3D) Object

The device of manufacturing a 3D object of the present disclosure can be a known device. For example, the following device can be used. That is, the device includes a powder material layer forming device to form a layer of the powder material for 3D modeling, a liquid material supplying (applying) device for 3D modeling to supply (apply) the liquid material for 3D modeling to the layer of the powder material for 3D modeling, and other optional devices such as a powder material container, a liquid material container, and a drier.

Powder Material Layer Forming Device for 3D Modeling

The powder material layer forming device forms a powder material layer having a desired thickness on a substrate or the powder material layer for 3D modeling using the powder material layer for 3D modeling.

The substrate is a base plate on which the powder material for 3D modeling is placed and can be a known substrate. The surface of the substrate can be smooth or coarse or plane or curved plane. Preferably, the surface has a good releasing property.

The method of placing the powder material for 3D modeling on the substrate has no particular limit and can be selected to a particular application. For example, known methods such as a method using a known counter rotation mechanism (counter roller), a method of forming a layer of the powder material for 3D modeling using a member such as a brush, a roller, and a blade, a method of pressing the surface of the powder material for 3D modeling using a pressure member to form a layer are suitably used. The layer of the powder material for 3D modeling formed by the method described above preferably has a smooth surface and a high filling ratio. Such a layer can reduce peeling-off between layers and improve the strength and the dimension accuracy of an obtained three-dimensional object. From this point of view, rollers and blades are preferably used among these powder material layer forming devices.

The average thickness of the powder material layer for 3D modeling is not particularly limited. For example, the average thickness for a single layer is preferably from 20 μm to 500 μm and more preferably from 50 μm to 300 μm. When the average thickness of the powder material layer for 3D modeling is 20 μm or more, the liquid material for 3D modeling can be applied appropriately to improve dimension accuracy. The modeling time becomes appropriate and the manufacturing efficiency of a 3D object is improved. In addition, when the average thickness of the powder material layer for 3D modeling is 500 μm or less, the obtained 3D object is free of peeling-off between the layers and has good dimension accuracy and strength. This leads to a sintered compact free of voids and prevention of deterioration of strength when the sintered compact is obtained by sintering the 3D object.

The average thickness of the powder material layer for 3D modeling can be measured by a known method such that the cross section of a 3D object is observed by using a scanning type electron microscope or a laser microscope.

Liquid Material Supplying Device for 3D Modeling

The liquid material supplying device for 3D modeling applies the liquid material for 3D modeling to the powder material layer for 3D modeling. The device of supplying liquid material for 3D modeling to the powder material for 3D modeling has no particular limit. For example, a dispenser method, a spray method, or an inkjet method is suitable.

The dispenser method is a general term for a device capable of supplying a fixed quantity of a liquid with high accuracy. This method is excellent in terms of supplying a fixed quantity but has a large application area, which may limit the size of a three-dimensional object. The spraying method uses a device for spraying a liquid atomized by compressed air, high pressurized gas, etc. The method has good applicability because the application area is large. However, the quantity property of liquid droplets is inferior so that powder scatters due to the spray stream, which leads to deterioration of the dimension accuracy of an obtained 3D object.

The inkjet method uses a device capable of discharging extremely fine liquid droplets by using piezoelectric elements or heater. That is, the device discharges fine droplets with good quantity property, which is advantageous to manufacture a complex 3D object with high precision and high efficiency.

Therefore, the inkjet method is particularly preferably used for the liquid material supplying device for 3D modeling in the present disclosure. In the present disclosure, since the base material is covered with the resin, the resin is not necessarily contained in the liquid material for 3D modeling. For this reason, the liquid material for 3D modeling can keep viscosity low and reduce the occurrence of clogging in nozzles by filming due to drying. Therefore, the inkjet head can be efficiently used.

In addition, when the liquid material for 3D modeling is applied to the powder material layer for 3D modeling, the liquid material for 3D modeling efficiently permeates into the resin, which leads to good manufacturing efficiency of a 3D object. This is advantageous to manufacture a 3D object having a sufficient strength and good dimension accuracy.

Other Devices

The other devices includes, for example, powder material containing unit (container), a liquid material containing unit (container), and a drier.

The powder material containing unit contains the powder material for 3D modeling. The size, forms, materials, etc. thereof are not particularly limited. For example, a storage tank, a bag, a cartridge, or a tank is suitably selected to a particular application.

The liquid material for 3D modeling unit contains the liquid material for 3D modeling. The size, forms, materials, etc. thereof are not particularly limited. For example, a storage tank, a bag, a cartridge, or a tank is suitably selected to a particular application.

The drier evaporates the liquid material for 3D modeling in the 3D object to dry the 3D object. The drier can be integrated into or separated from a device for manufacturing a 3D object. In addition, the powder material layer for 3D modeling can be dried a layer by layer or after all the layers are laminated. By providing such a drier, the strength of a 3D object can be improved sooner so that the risk of losing shape or deformation of the 3D object is reduced. In addition, when a cross-linking agent is contained in the liquid material for 3D modeling, the strength of a 3D object can be improved sooner by such a drier. On the other hand, by excessive drying, the powder material for 3D modeling to which the liquid material for 3D modeling is not attached is also thermally fused and attached, thereby degrading the dimension accuracy of the 3D object.

Specifically, the device for manufacturing a 3D object of the present disclosure includes a powder storage tank for supplying (also referred to as supplying tank), a powder storage tank for 3D modeling (also referred to as modeling tank), a powder material layer forming device for 3D modeling including a roller and a powder removing plate, a liquid material supplying device for 3D modeling including a head and a head cleaning mechanism, and optional members such as a powder material container.

The powder storage tank has a tank-like form or a box-like form and the stage constituting the base of the tank can be elevated up and down along a perpendicular direction. In addition, the supplying tank and the 3D modeling tank are disposed side by side. A 3D object is formed on the stage of the modeling tank. The stage of the supplying tank is lifted and the powder material layer in the supplying tank is supplied to the stage of the supplying tank using the powder material layer forming device for 3D modeling including a smoothing roller. The powder material layer forming device for 3D modeling smoothes the upper surface of the powder material placed on the stage of the supplying tank and the modeling tank to form a powder material layer.

The liquid material supplying device for 3D modeling using a head is used to discharge the liquid material for 3D modeling to the powder material layer for 3D modeling formed on the stage. The head cleaning mechanism attaches to the head, suctions the liquid material for 3D modeling, and wipes the discharging mouth.

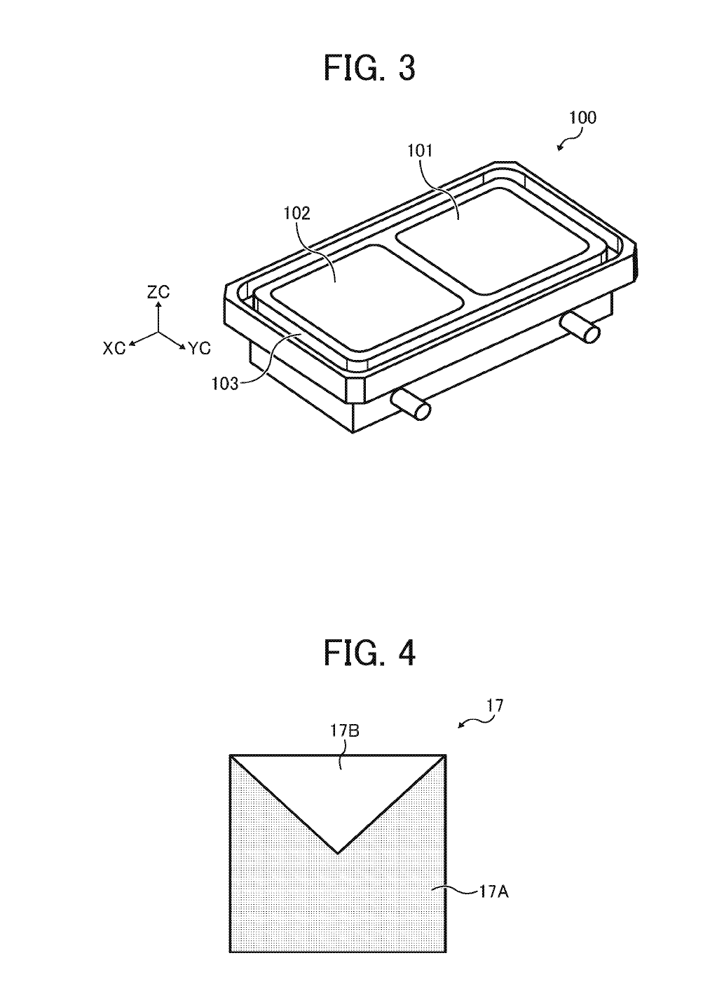

FIG. 3 is a schematic diagram illustrating a powder storage tank of the device of manufacturing a 3D object. The powder storage tank 100 has a box-like form and includes a supplying tank 102 and a modeling tank 101 with the upper faces of the two tanks open.

The stages are held inside each of the supplying tank 102 and the modeling tank 101. Each side of the stages is placed adjacent to the frames of the tanks and the upper surface of the stage is held horizontally. Around these powder storage tanks 100, a powder dropping mouth 103 having a concave-like form is disposed with the upper surface open. Extra powder material accumulated by the smoothing roller when forming a powder material layer is dropped to the powder dropping mouth 103. The extra powder dropped to the powder dropping mouth 103 is returned to the powder supplying unit disposed above the modeling tank 101 by an operator or a suction mechanism, if desired.

The powder material container has a tank-like form and disposed above the supplying tank 102. When the amount of the powder material in the supplying tank 102 decreases or at the time of initial operation of modeling, the powder in the tank is supplied to the supplying tank 102. As the method of conveying powder to supply the powder, for example, a screw conveyor method using a screw or an air transfer method using air is suitable.

The smoothing roller has a feature to transfer the powder material from the supplying tank 102 to the modeling tank 101 to form a powder material layer having a desired thickness (for example, Δt1−Δt2).

The smoothing roller is a stick longer than the inside dimension of the modeling tank 101 and the supplying tank 102 (that is, the portion where the powder material is supplied or stored) and is supported at both ends in such a manner that both ends reciprocate.

The smoothing roller rotates and horizontally moves while passing through the portion above the supplying tank 102 and the modeling tank 101 from the outside of the supplying tank 102 to supply the powder material onto the modeling tank 101. Specifically, the stage of the supplying tank 102 is elevated and the stage of the modeling tank 101 is lowered.

It is preferable that the lowering distance is set in such a manner that the gap between the uppermost powder material layer of the modeling tank 101 and the lower part of (lower tangent portion) of the smoothing roller is equal to Δt1. In this embodiment, Δt1 is preferably from 50 μm to 300 μm. For example about 150 μm is suitable.

Next, the smoothing roller is rotated and moved to supply the powder deposited above the upper surface level of the supplying tank 102 to the modeling tank 101, thereby forming a powder layer having a desired thickness of Δt1 on the stage of the modeling tank 101. The smoothing roller is set to move while keeping the distance between the smoothing roller and the upper surface level of the modeling tank 101 and the supplying tank 102 constant. As a result, a powder material layer having a uniform thickness can be formed on the modeling tank 101 or the layer already formed on the modeling tank 101 while moving the powder onto the modeling tank 101 by the smoothing roller.

The smoothing roller preferably rotates in the counter direction (reverse rotation) to the direction of the horizontal movement to transfer powder materials. However, the roller may rotate in the reverse direction (proper rotation) to the counter direction to increase the density of the powder material. In addition, after the roller reversely rotates and horizontally moves, it is possible to elevate the stage of the modeling tank 101 in an amount of Δt2 and properly rotate and horizontally move the roller to improve transfer of the powder and the density. In this embodiment, Δt2 is preferably from 50 μm to 100 μm. For example about 50 μm is suitable. The difference (Δt1−Δt2) corresponds to the thickness of the modeled layer in the modeling tank 101, that is, the pitch of lamination.

In addition, the smoothing roller preferably includes a powder removing plate to remove powder material attached to the smoothing roller. The powder removing plate is preferably disposed adjacent to the roller at the position in the powder-not-smoothed area and below the rotation center of the roller to prevent powder attached to the roller from scattering to the smoothed area. A blade of a square log is also suitable as the smoothing member in addition to the roller. The smoothing member and the drive condition can be changed depending on the properties (such as degree of agglomeration of particle and flowability) of the powder material and the storage state (such as storage in a high humid environment) of the powder material. In addition, the drive condition can be changed depending on the high density condition.

The head includes a cyan head, a magenta head, a yellow head, a black head, and a clear head. Multiple tanks including each of a cyan modeling liquid material, a magenta modeling liquid material, a yellow modeling liquid material, a black modeling liquid material, or a clear modeling liquid material are installed inside the device for manufacturing a 3D object. Each color head is connected with a tank containing a corresponding color liquid material by a flexible tube. The head is controlled to discharge the liquid material of each color to the powder material layer. The number of heads and the kind of the liquid material to be discharged can be changed.

For example, if coloring a 3D object is not necessary, it is possible to set only a clear head to discharge only the clear modeling liquid material. The head can be moved to Y axis direction and Z axis direction utilizing a guide rail. When the surfaces of the supplying tank and the modeling tank are smoothed and made highly-dense by the smoothing roller, the head is moved to the position where the head does not interfere.

When the liquid material discharged by the head is mixed with the powder material, the resin contained in the powder material is dissolved and the powder material adjacent to each other adhere to each other. As a result, a modeled layer having a thickness of (Δt1−Δt2) is formed.

Thereafter, the powder supplying step, the smoothing step, the high-density step, and the liquid material discharging step by the head described above are repeated to form a new modeled layer. At this point, the newly formed modeled layer and the layer just below are integrated to form a part of a 3D object. Thereafter, manufacturing of the 3D object is complete by repeating the step of the powder material supplying and smoothing, the step of the high-density, and the step of the liquid material discharging by the head a required number of times.

The head cleaning mechanism mainly includes a cap and a wiper blade. The cap is caused to adhere to the nozzle surface forming the lower part of the head and suctions the modeling liquid from the nozzle. This is to evacuate powder material clogged in the nozzle and highly-thickened liquid material. Thereafter, due to the meniscus forming caused by negative pressure in the nozzle, the nozzle surface is wiped.

In addition, when the liquid material is not discharged, the head cleaning mechanism covers the nozzle surface to prevent the powder material from being mixed into the nozzle or the liquid material from being dried.

The thickness of the powder material layer, the drive condition of the smoothing device, and high-density drive condition can be changed depending on the material or the particle diameter of the powder material to be used and target accuracy.

Three-Dimensional (3D) Object

The 3D object of the present disclosure is modeled by using the powder material for 3D modeling of the present disclosure and has a good strength and extremely low level of local variation of strength.

It is preferable that the average bend stress of the 3D object is 3.0 MPs or greater and the standard deviation of is 0.5 or less. It is more preferable that the average bend stress of the 3D object is 3.0 MPs or greater and the standard deviation of is 0.3 or less.

The average bend stress of the 3D object and its standard deviation can be obtained by, for example, a bend stress test by using a precision universal tester (Autograph AGS-J, manufactured by Shimadzu Corporation). The bend stress is measured using a three-point bend test jig and a load cell for 1 kN while setting the difference between the supporting points to 24 mm. The stress when fractured is defined as the maximum stress. The same tests are conducted at three arbitrary points of the 3D object to obtain the average bend stress and the standard deviation a.

Degreasing and Sintering of Three-Dimensional (3D) Object

Optionally, the obtained 3D object is degreased and sintered.

Degreasing means treatment of removing resins. In the degreasing treatment, unless the resin is sufficiently removed, a sintered compact may be deformed or cracked in the sintering treatment conducted subsequent to manufacturing of a 3D object. As the degreasing method, a sublimation method, a solvent extraction method, a natural drying method, or a heating method are suitable. Of these, the heating method is preferable.

The heating method includes heat treatment of degreasing an obtained 3D object at degreasable temperatures. The heat treatment is conducted in the atmosphere, or optionally in vacuum or with a reduced pressure, a non-oxidization atmosphere, a pressurized atmosphere, or a gas atmosphere such as nitrogen gas, argon gas, hydrogen gas, and ammonium decomposition gas. The time and temperature of degreasing can be appropriately set depending on base materials or resins. Since the powder material for 3D modeling of the present disclosure uses the polyvinyl alcohol mentioned above as the resin, the degreasing treatment temperature is relatively low. For this reason, the time can be shortened and the manufacturing efficiency of a sintered compact is improved in the present disclosure.

In addition, degreasing according to such heat treatment can be separated into multiple processes. For example, the heat treatment temperature can be changed between the first half and the second half or alternated between low temperatures and high temperatures.

The resin is not necessarily completely removed by this degreasing treatment, that is, part of the resin may remain at the time of completion of the degreasing. Sintering means consolidation of powder at high temperatures. The degreased matter obtained after the degreasing treatment process is sintered at a sintering furnace to obtain a sintered compact. As a result of sintering, the base material of the powder material for 3D modeling diffuses and granulates, so that a dense sintered compact having less voids with a high strength is obtained.

The conditions such as temperatures, time, atmospheres, and the temperature rising speed are determined depending on the composition of the base material and degreased state, size, and form of the 3D object. However, if the sintering temperature is too low, sintering does not proceed sufficiently, thereby degrading the strength and density of a sintered compact. However, if the sintering temperature is too high, the dimension accuracy of a sintered compact may deteriorate. The sintering atmosphere has no particular limit. For example, in addition to the atmosphere, the sintering can be conducted in vacuum or with a reduced pressure, a non-oxidization atmosphere, or an atmosphere of inert gas such as nitrogen gas, and argon gas.

In addition, sintering can be conducted by two or more steps. For example, it is possible to conduct a primary sintering and a secondary sintering having different sintering conditions, sintering temperatures, sintering time, or sintering atmospheres.

In the powder material for 3D modeling of the present disclosure, the base material is covered with the resin. Therefore, the amount of the resin is small, which makes it possible to reduce degreasing and deformation and contraction, etc. of a 3D object before and after sintering.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

Base Material (Core Material)

Base Material 1
Stainless steel (SUS316L, manufactured by SANYO SPECIAL STEEL Co., Ltd.)
Volume average particle diameter: 45 μm
Specific gravity: 8

Base Material 2
Stainless steel (SUS316L, manufactured by SANYO SPECIAL STEEL Co., Ltd.)
Volume average particle diameter: 13 μm
Specific gravity: 8

Base Material 3
Stainless steel (SUS316L, manufactured by Sandvik AB)
Volume average particle diameter: 11 μm
Specific gravity: 8

Base Material 4
Stainless steel (SUS316L, manufactured by Daido Steel Co., Ltd.)
Volume average particle diameter: 15 μm
Specific gravity: 8

Preparation of Coating Liquid

Preparation of Coating Liquid 1

114 parts by mass of deionized water was mixed with 5.4 parts by mass of acetoacetyl group-modified polyvinyl alcohol (Z-100, average degree of polymerization: 500, manufactured by The Nippon Synthetic Chemical Industry Co., Ltd.) and 0.6 part by mass of methyl cellulose (SMC-25, manufactured by Shin-Etsu Chemical Co., Ltd.). The mixture was stirred for two hours using a three one motor (BL600, manufactured by SHINTO Scientific Co., Ltd.) while being heated at 80 degrees C. in a water bath followed by three-hour cooling. As a result, 120 parts by mass of an aqueous solution of acetoacetyl group-modified polyvinyl alcohol and methyl cellulose having a concentration of 5 percent by mass was obtained. The thus-prepared liquid was referred to as [Coating liquid 1].

Preparation of Coating Liquid 2

114 parts by mass of deionized water was mixed with 5.4 parts by mass of diacetone acrylamide-modified polyvinylalcohol (DF-05, average degree of polymerization: 500, manufactured by JAPAN VAM & POVAL CO., LTD.) and 0.6 part by mass of methyl cellulose (SMC-25, manufactured by Shin-Etsu Chemical Co., Ltd.). The mixture was stirred for two hours using a three one motor (BL600, manufactured by SHINTO Scientific Co., Ltd.) while being heated at 80 degrees C. in a water bath followed by three-hour cooling. As a result, 120 parts by mass of an aqueous solution of diacetone acrylamide-modified polyvinylalcohol and methyl cellulose having a concentration of 5 percent by mass was obtained. The thus-prepared liquid was referred to as [Coating liquid 2].

Preparation of Coating Liquid 3

114 parts by mass of deionized water was mixed with 5.4 parts by mass of completely saponified polyvinyl alcohol (KL105, average degree of polymerization: 500, manufactured by KURARAY CO., LTD.) and 0.6 part by mass of methyl cellulose (SMC-25, manufactured by Shin-Etsu Chemical Co., Ltd.). The mixture was stirred for two hours using a three one motor (BL600, manufactured by SHINTO Scientific Co., Ltd.) while being heated at 80 degrees C. in a water bath followed by three-hour cooling. As a result, 120 parts by mass of an aqueous solution of completely saponified polyvinyl alcohol and methyl cellulose having a concentration of 5 percent by mass was obtained. The thus-prepared liquid was referred to as [Coating liquid 3].

Preparation of Coating Liquid 4

114 parts by mass of deionized water was mixed with 5.4 parts by mass of dipropanediol polyvinyl alcohol (Nichigo G-Polymer™ OKS-8041, manufactured by The Nippon Synthetic Chemical Industry Co., Ltd.) and 0.6 parts by mass of methyl cellulose (SMC-25, manufactured by Shin-Etsu Chemical Co., Ltd.). The mixture was stirred for two hours using a three one motor (BL600, manufactured by SHINTO Scientific Co., Ltd.) while being heated at 80 degrees C. in a water bath followed by three-hour cooling. As a result, 120 parts by mass of an aqueous solution of dipropanediol polyvinyl alcohol and methyl cellulose having a concentration of 5 percent by mass was obtained. The thus-prepared liquid was referred to as [Coating liquid 4].

Method 1 of Manufacturing Powder Material for 3D Modeling

Coating Conditions 1: Tumbling Fluidized Bed Coat:

Tumbling fluidized bed coating device: MP-01, manufactured by POWREX CORPORATION
Amount of base particle: 1,000 g
Spray setting

Nozzle diameter: 1.2 mm

Coating liquid discharging pressure: 4.7 Pa·s

Coating liquid discharging speed: 3 g/min.

Atomize air amount: 50 NL/min
Rotor setting

Rotation speed: 60 rpm

Number of rotation: 400 percent
Air stream setting

Air supply temperature: 80 degrees C.

Air supply amount: 0.8 m3/min.

Bug filter shaking pressure: 0.2 MPa

Bug filter shaking time: 0.3 seconds

Bug filter interval: 5 seconds
Coating time: 80 minutes

Method 2 of Manufacturing Powder Material for 3D Modeling

Coating Conditions 2: dipping coating
Amount of base particle: 8,000 g (changed depending on specific gravity of base material)
Coating method (dripping, dipping (if desired, spray coverage)
Agitator (Mixed Wing)/Chopper (Disintegration wing) rotation setting
   1: Agitator rotation

Rotation speed: 160 rpm

2: Chopper rotation

Rotation speed: 1,200 rpm

### Other Conditions

Jacket setting temperature: 60 degreed C

Vacuum degree in Layer: −0.08 MPa to −0.05 MPa
Coating time: 180 minutes

Disintegration Treatment

Disintegration Condition 1

A collision disintegration method using ultrasonic drying air is used.

With an air pressure (adjusting air pressure depending on base material and agglomeration state) of 0.6 MPa, agglomeration bodies are disintegrated by collision with a ceramic collision board. The amount of processing feed is 30 g/min. The particle diameter after disintegration is arbitrarily adjusted. The target particle diameter is an original particle diameter of the base material.

Disintegration Condition 2

100 g of zirconia ball having a diameter of 0.5 mm and 30 g of target powder to be disintegrated are weighed into a bin (200 ml) and disintegrated by a paint shaker (manufactured by ASADA IRON WORKS. CO., LTD.). Thereafter, the resultant is separated into powder and beads by a mesh having an opening of 150 μm and a linear diameter of 100 μm. The disintegration time can be arbitrarily determined.

Disintegration Condition 3

100 g of zirconia ball having a diameter of 1.0 mm and 30 g of target powder to be disintegrated are weighed into a bin (200 ml) and disintegrated by a paint shaker (manufactured by ASADA IRON WORKS. CO., LTD.). Thereafter, the resultant is separated into powder and beads by a mesh having an opening of 150 μm and a linear diameter of 100 μm. The disintegration time can be arbitrarily determined.

### Example 1

### Preparation of Powder Material 1 for 3D Modeling

[Base material 1] was coated with [Coating liquid 1] by [Method 1 of manufacturing powder material for 3D modeling] for resin coating. Thereafter, the resultant was subject to disintegration treatment under [Disintegration condition 1] to manufacture [Powder material 1 for 3D modeling]. Recipes of [Base material 1] and [Coating liquid 1] are shown in Table 1.

The aspect ratio, the attachment amount of resin, the volume average particle diameter, the particle size distribution, the coverage thickness, and the resin coverage factor of the thus-obtained [Powder material 1 for 3D modeling] were measured in the following manner. The results are shown in Tables 1 and 2.

Aspect Ratio (Average Value)

The aspect ratio was measured by a particle form measuring device (Morphologi G3-SE, manufactured by Spectris Co., Ltd.) under the measuring conditions of a dispersion pressure of 4 bar, a compressed air applying time: 10 ms, leave to rest time: 60 seconds, number of measuring particles: 50,000, and degree of area envelope for filtering. Only particles considered as primary particles were subject to analysis.

The degree of area envelope means a value obtained by dividing the area 17A of the particle 17 with the total area (17A+17B) of the entire particle enclosed by the convex envelope as illustrated in FIG. 4. The degree of area envelope is represented by the value of from 0 to 1 as shown in the following relation 2 and indicates how jagged the particle is. Filtering was conducted by the degree of area envelop >0.99>100 pixels and the number of measuring particles after filtering was 15,000 or more.

Degree of area envelope of particle={area 17A of particle}/{area(17A+17B) of entire particle} Relation 2

The aspect ratio (average) was obtained by obtaining each aspect ratio (minor axis/major axis) of each particle for use in analysis and thereafter weighing with how much the particle having each aspect ratio existed in the analyzed entire particles and calculated by the following Relation 1:

Aspect ratio (average value)=X1×Y1/100+X2×Y2/100+ . . . +Xn×Yn/100, Relation 1

In the Relation 1, Y1+Y2+Yn=100 (percent), Xn represents the aspect ratio (minor axis/major axis), Yn represents an existence ratio (percent) of a particle having an aspect ratio of Xn, and n is 15,000 or greater.

Attached Amount of Resin

The amount of attachment of the resin of the thus-obtained [Powder material 1 for 3D modeling] was obtained based on mass reduction ratio by heating to 400 degrees C. using a thermogravimetric analyzer (TGA-50, manufactured by Shimadzu Corporation).

Volume Average Particle Diameter and Particle Size Distribution

The volume average particle diameter of [Powder material 1 for 3D modeling] was measured by using a laser diffraction/diffusion type particle size distribution measuring device (Microtrac MT3000II series, manufactured by MicrotracBEL Corp.) to obtain a frequent distribution and a cumulative volume distribution curve. According to the cumulative volume distribution curve, D10, volume average particle diameter (D50), and D90 were calculated to obtain D90/D10.

Coverage Thickness (Average Thickness)

A sample for observation for coverage thickness (average thickness) was prepared by polishing the surface of [Powder material 1 for 3D modeling] by emery paper and thereafter slightly polishing the surface with a wet cloth to dissolve the resin portion.

Next, the border between the base portion and the resin portion exposed to the surface was observed by a field-emission-type scanning electron microscope (FE-SEM) and the length between the surface of the resin portion and the border was measured as the coverage thickness. Thereafter, the average of ten measured points was obtained and determined as the coverage thickness (average thickness).

Resin Coverage Ratio

Using a field-emission-type scanning electron microscope (FE-SEM), Energy Selective Backscatter (ESB) was taken under the following conditions with a field of vision in which the number of [Powder material 1 for 3D modeling] was around ten in an image followed by image processing using Image J software for binarization. The coverage portion was black while the base material was white. The rate of {black portion area/(black portion area+white portion area)} in a particle was obtained. 10 particles were measured and the average value of the 10 particles was determined as the resin coverage factor (percent).

SEM Observation Condition
Signal: ESB (backscattered electron image)
EHT: 0.80 kV
ESB Grid: 700 V
WD: 3.0 mm
Aperture Size: 30.00 μm
Contrast: 80 percent
Magnification: set for each sample in order to have around ten particles in the horizontal direction of screen

Preparation of Liquid Material 1 for 3D Modeling

60 parts of water and 40 parts of 1,2-butane diol (manufactured by Tokyo Chemical Industry Co. Ltd.) serving as a water-soluble solvent (humectant) were mixed and stirred to manufacture [Liquid material 1 for 3D modeling].

Manufacturing of Three-dimensional (3D) Object 1

Using the device for manufacturing a 3D object illustrated in FIG. 3 including a counter roller as the powder material layer forming device for 3D modeling and an inkjet head as the liquid material supplying device for 3D modeling, [3D object 1] was manufactured according to the following manner. [Powder material 1 for 3D modeling] was placed in the powder material containing unit of the device for manufacturing a 3D object and [Liquid material 1 for 3D modeling] was placed in the liquid material containing unit, 3D data were input, and the processes illustrated in FIGS. 1A to 1F were repeated to manufacture [3D object 1] having a reed-like form. The average thickness of a single layer of the powder material layer for 3D modeling was adjusted to be about 10 μm to laminate 30 layers in total.

After air drying for about two hours, [3D object 1] was placed in a drier for drying at 70 degrees C. for three hours. Thereafter, powder material for 3D modeling to which the liquid material for 3D modeling was not attached was removed by a brush, etc. [3D object 1] was placed in the drier again for drying at 100 degrees C. for 12 hours followed by being cooled down to room temperature to obtain [3D object 1].

Bend Stress Test of Three-Dimensional (3D) Object

The bend stress test of [3D object 1] was conducted using a precision universal tester (Autograph AGS-J, manufactured by Shimadzu Corporation). The bend stress was measured using a three-point bend test jig and a load cell for 1 kN and setting the distance between the supporting points to 24 mm. The stress when fractured was defined as the maximum stress. The same tests were conducted at three arbitrary points of [3D object 1] to obtain the average bend stress and the standard deviation a. The results were evaluated according to the following criteria. The results are shown in Table 2.

Evaluation Criteria of Average Bend Stress

A: 9.0 MPa or more
B: 6.0 MPa to less than 9.0 MPa
C: 3.0 MPa to less than 6.0 MPa
D: Less than 3.0 MPa

Evaluation Criteria of Variation

D: σ was greater than 0.5
C: σ was greater than 0.3 to 0.5
B: σ was greater than 0.1 to 0.3
A: σ was 0.1 or less

Degreasing and Sintering of Three-dimensional (3D) Object

The obtained [3D object 1] was placed in a drier and heated to 500 degrees C. in four hours in a nitrogen atmosphere.

After maintaining the temperature at 500 degrees C. for four hours, [3D object 1] was degreased. The thus-obtained degreased matter was subject to sintering treatment at 1,200 degrees C. in a vacuum condition in a sintering furnace to manufacture [Sintered compact 1].

### Examples 2 to 19 and Comparative Examples 1 to 5

3D objects of Examples 2 to 19 and Comparative Examples 1 to 5 were manufactured and evaluated in the same manner as in Example 1 except that the kind and the amount of the base material, the method of manufacturing a powder material for 3D modeling, the liquid material for 3D modeling, and the disintegration condition were changed as shown in Table 1. The results are shown in Tables 1 and 2.

Preparation of Liquid Material 2 for 3D Modeling

60 parts of water, 40 parts of 1,2-butane diol (manufactured by Tokyo Chemical Industry Co., Ltd.), and 3 parts by mass of an ammonium salt of zirconium carbonate (Zircosol AC20, manufactured by DAIICHI KIGENSO KAGAKU KOGYO CO., LTD.) as cross-linking agent were mixed and stirred to prepare [Liquid material 2 for 3D modeling].

Preparation of Liquid Material 3 for 3D Modeling

60 parts of water, 40 parts of 1,2-butane diol (manufactured by Tokyo Chemical Industry Co. Ltd.), and 0.5 parts by mass of a glyoxyl acid ester (SMP02, manufactured by The Nippon Synthetic Chemical Industry Co., Ltd.) as cross-linking agent were mixed and stirred to prepare [Liquid material 3 for 3D modeling].

Preparation of Liquid Material 4 for 3D Modeling

60 parts of water, 40 parts of 1,2-butane diol (manufactured by Tokyo Chemical Industry Co. Ltd.) serving as a water-soluble solvent (humectant), and 0.8 parts by mass of an adipic acid ester (ADH, manufactured by JAPAN FINECHEM COMPANY, INC.) as cross-linking agent were mixed and stirred to prepare [Liquid material 4 for 3D modeling].

TABLE 1-1

| | Base material | | | | |
|---|---|---|---|---|---|
| | | Volume | | | |
| | | average | Coating condition | | |
| | | particle | | | Amount |
| | Kind of | diameter | | | of |
| | base | of base | Coating | Coating | coating |
| | material | material | device | liquid | resin |
| Example 1 | Base | 45 μm | Manufacturing | Coating | 220 g |
| | material 1 | | method 1 | liquid 1 | |
| Example 2 | Base | 13 μm | Manufacturing | Coating | 220 g |
| | material 2 | | method 1 | liquid 1 | |
| Example 3 | Base | 45 μm | Manufacturing | Coating | 220 g |
| | material 1 | | method 1 | liquid 1 | |
| Example 4 | Base | 13 μm | Manufacturing | Coating | 220 g |
| | material 2 | | method 1 | liquid 1 | |
| Example 5 | Base | 13 μm | Manufacturing | Coating | 220 g |
| | material 2 | | method 1 | liquid 1 | |
| Example 6 | Base | 13 μm | Manufacturing | Coating | 150 g |
| | material 2 | | method 1 | liquid 1 | |
| Example 7 | Base | 13 μm | Manufacturing | Coating | 300 g |
| | material 2 | | method 1 | liquid 1 | |
| Example 8 | Base | 13 μm | Manufacturing | Coating | 220 g |
| | material 2 | | method 2 | liquid 1 | |
| Example 9 | Base | 15 μm | Manufacturing | Coating | 220 g |
| | material 4 | | method 2 | liquid 1 | |
| Example 10 | Base | 11 μm | Manufacturing | Coating | 220 g |
| | material 3 | | method 2 | liquid 1 | |
| Example 11 | Base | 13 μm | Manufacturing | Coating | 220 g |
| | material 2 | | method 1 | liquid 2 | |
| Example 12 | Base | 13 μm | Manufacturing | Coating | 220 g |
| | material 2 | | method 1 | liquid 3 | |
| Example 13 | Base | 13 μm | Manufacturing | Coating | 220 g |
| | material 2 | | method 1 | liquid 4 | |
| Example 14 | Base | 13 μm | Manufacturing | Coating | 220 g |
| | material 2 | | method 1 | liquid 3 | |
| Example 15 | Base | 13 μm | Manufacturing | Coating | 150 g |
| | material 2 | | method 1 | liquid 3 | |
| Example 16 | Base | 13 μm | Manufacturing | Coating | 300 g |
| | material 2 | | method 1 | liquid 3 | |
| Example 17 | Base | 13 μm | Manufacturing | Coating | 220 g |
| | material 2 | | method 1 | liquid 1 | |
| Example 18 | Base | 13 μm | Manufacturing | Coating | 220 g |
| | material 2 | | method 1 | liquid 1 | |
| Example 19 | Base | 13 μm | Manufacturing | Coating | 220 g |
| | material 2 | | method 1 | liquid 1 | |
| Comparative | Base | 13 μm | Manufacturing | Coating | 220 g |
| Example 1 | material 2 | | method 1 | liquid 3 | |
| Comparative | Base | 13 μm | Manufacturing | Coating | 220 g |
| Example 2 | material 2 | | method 1 | liquid 3 | |
| Comparative | Base | 13 μm | Manufacturing | Coating | 300 g |
| Example 3 | material 2 | | method 1 | liquid 3 | |
| Comparative | Base | 13 μm | Manufacturing | Coating | 90 g |
| Example 4 | material 2 | | method 1 | liquid 3 | |
| Comparative | Base | 15 μm | Manufacturing | Coating | 300 g |
| Example 5 | material 4 | | method 1 | liquid 3 | |

TABLE 1-2

| | Liquid material | | | | | |
|---|---|---|---|---|---|---|
| | for 3D modeling | | Disintegration treatment | | | |
| | | Kind of | | Condition | Time | |
| | | cross- | | amount of | (Time or | |
| | | linking | Disintegration | disintegration | number | |
| | No. | agent | condition | 1,000 g | of times) | |
| Example 1 | 1 | — | None | None | None | |
| Example 2 | 1 | — | None | None | None | |
| Example 3 | 1 | — | Disintegration | LJ mill | 1 | pass |
| | | | condition 1 | | | |
| Example 4 | 1 | — | Disintegration | LJ mill | 1 | pass |
| | | | condition 1 | | | |
| Example 5 | 1 | — | Disintegration | Zr ball | 1 | hour |
| | | | condition 2 | diameter | | |
| | | | | 0.5 mm | | |
| Example 6 | 1 | — | Disintegration | LJ mill | 1 | pass |
| | | | condition 1 | | | |
| Example 7 | 1 | — | Disintegration | LJ mill | 1 | pass |
| | | | condition 1 | | | |
| Example 8 | 1 | — | Disintegration | LJ mill | 1 | pass |
| | | | condition 1 | | | |
| Example 9 | 1 | — | Disintegration | LJ mill | 1 | pass |
| | | | condition 1 | | | |
| Example 10 | 1 | — | Disintegration | LJ mill | 1 | pass |
| | | | condition 1 | | | |
| Example 11 | 1 | — | Disintegration | LJ mill | 1 | pass |
| | | | condition 1 | | | |
| Example 12 | 1 | — | Disintegration | LJ mill | 1 | pass |
| | | | condition 1 | | | |
| Example 13 | 1 | — | Disintegration | LJ mill | 1 | pass |
| | | | condition 1 | | | |
| Example 14 | 1 | — | Disintegration | Zr ball | 1 | hour |
| | | | condition 2 | diameter | | |
| | | | | 0.5 mm | | |
| Example 15 | 1 | — | Disintegration | LJ mill | 1 | pass |
| | | | condition 1 | | | |
| Example 16 | 1 | — | Disintegration | LJ mill | 1 | pass |
| | | | condition 1 | | | |
| Example 17 | 2 | Ammonium | Disintegration | LJ mill | 1 | pass |
| | | salt of | condition 1 | | | |
| | | zirconium | | | | |
| | | carbonate | | | | |
| Example 18 | 3 | Glyoxyl | Disintegration | LJ mill | 1 | pass |
| | | acid ester | condition 1 | | | |
| Example 19 | 4 | Adipic acid | Disintegration | LJ mill | 1 | pass |
| | | dihydrazide | condition 1 | | | |
| Comparative | 1 | — | Disintegration | Zr ball | 2 | hours |
| Example 1 | | | condition 2 | diameter | | |
| | | | | 0.5 mm | | |
| Comparative | 1 | — | Disintegration | Zr ball | 2 | hours |
| Example 2 | | | condition 3 | diameter | | |
| | | | | 1 mm | | |
| Comparative | 1 | — | Disintegration | Zr ball | 1 | hour |
| Example 3 | | | condition 3 | diameter | | |
| | | | | 1 mm | | |
| Comparative | 1 | — | Disintegration | LJ mill | 1 | pass |
| Example 4 | | | condition 1 | | | |
| Comparative | 1 | — | Disintegration | Zr ball | 1 | hour |
| Example 5 | | | condition 3 | diameter | | |
| | | | | 1 mm | | |

TABLE 1-3

| | Volume average particle | | | | | | | |
|---|---|---|---|---|---|---|---|---|
| | diameter | | | | | | | Attached |
| | Particle | Particle | Particle size | | | | Resin | amount |
| | diameter | diameter | distribution | | | | coverage | of resin |
| | after | after | D₁₀ | D₉₀ | | Aspect | ratio | (percent |
| | coating | disintegration | (μm) | (μm) | D₉₀/D₁₀ | ratio | (percent) | by mass) |
| Example 1 | 50 μm | — | 35 | 80 | 2.3 | 0.92 | 80 | 0.80 |
| Example 2 | 30 μm | — | 14 | 42 | 3.0 | 0.91 | 80 | 0.80 |
| Example 3 | — | 45 μm | 32 | 71 | 2.2 | 0.91 | 84 | 0.83 |
| Example 4 | — | 14 μm | 10 | 23 | 2.3 | 0.91 | 81 | 0.80 |
| Example 5 | — | 16 μm | 10 | 26 | 2.6 | 0.90 | 80 | 0.75 |
| Example 6 | — | 14 μm | 10 | 22 | 2.2 | 0.91 | 50 | 0.50 |
| Example 7 | — | 14 μm | 10 | 25 | 2.5 | 0.91 | 90 | 1.00 |
| Example 8 | — | 16 μm | 15 | 40 | 2.7 | 0.94 | 70 | 0.75 |
| Example 9 | — | 17 μm | 14 | 33 | 2.4 | 0.90 | 70 | 0.75 |
| Example 10 | — | 13 μm | 12 | 25 | 2.1 | 0.90 | 70 | 0.75 |
| Example 11 | — | 14 μm | 10 | 23 | 2.3 | 0.93 | 80 | 0.80 |
| Example 12 | — | 14 μm | 10 | 23 | 2.3 | 0.91 | 80 | 0.80 |
| Example 13 | — | 14 μm | 10 | 23 | 2.3 | 0.93 | 80 | 0.80 |
| Example 14 | — | 14 μm | 10 | 26 | 2.6 | 0.90 | 75 | 0.75 |
| Example 15 | — | 14 μm | 10 | 22 | 2.2 | 0.91 | 50 | 0.50 |
| Example 16 | — | 14 μm | 10 | 25 | 2.5 | 0.91 | 90 | 1.00 |
| Example 17 | — | 14 μm | 10 | 23 | 2.3 | 0.91 | 81 | 0.80 |
| Example 18 | — | 14 μm | 10 | 23 | 2.3 | 0.91 | 81 | 0.80 |
| Example 19 | — | 14 μm | 10 | 23 | 2.3 | 0.91 | 81 | 0.80 |
| Comparative | — | 13 μm | 10 | 24 | 2.4 | 0.89 | 68 | 0.72 |
| Example 1 | | | | | | | | |
| Comparative | — | 13 μm | 6 | 34 | 5.7 | 0.83 | 72 | 0.80 |
| Example 2 | | | | | | | | |
| Comparative | — | 13 μm | 8 | 34 | 4.3 | 0.87 | 90 | 0.90 |
| Example 3 | | | | | | | | |
| Comparative | — | 14 μm | 10 | 22 | 2.2 | 0.91 | 14 | 0.15 |
| Example 4 | | | | | | | | |
| Comparative | — | 13 μm | 6 | 38 | 6.3 | 0.80 | 89 | 0.90 |
| Example 5 | | | | | | | | |

TABLE 2

| | | Bend stress | | | | | | |
|---|---|---|---|---|---|---|---|---|
| | | | | | Average bend | | | |
| | Coverage | | | | stress | | | |
| | thickness | n1 | n2 | n3 | Value | | Standard deviation σ | |
| | (nm) | (MPa) | (MPa) | (MPa) | (MPa) | Evaluation | Value | Evaluation |
| Example 1 | 300 | 6.0 | 5.5 | 6.5 | 6.0 | B | 0.5 | C |
| Example 2 | 210 | 6.0 | 5.8 | 6.2 | 6.0 | B | 0.2 | B |
| Example 3 | 290 | 7.0 | 6.2 | 6.8 | 6.7 | B | 0.4 | C |
| Example 4 | 205 | 9.0 | 8.9 | 9.1 | 9.0 | A | 0.1 | A |
| Example 5 | 205 | 6.5 | 7.0 | 7.5 | 7.0 | B | 0.5 | C |
| Example 6 | 95 | 3.1 | 2.9 | 3.2 | 3.1 | C | 0.2 | B |
| Example 7 | 305 | 10.0 | 9.8 | 9.8 | 9.9 | A | 0.1 | A |
| Example 8 | 200 | 8.0 | 8.0 | 8.1 | 8.0 | B | 0.1 | A |
| Example 9 | 220 | 5.5 | 5.4 | 6.0 | 5.6 | C | 0.3 | B |
| Example 10 | 160 | 5.8 | 6.0 | 5.7 | 5.8 | C | 0.2 | B |
| Example 11 | 205 | 6.7 | 7.0 | 6.6 | 6.8 | B | 0.2 | B |
| Example 12 | 205 | 6.4 | 6.0 | 6.2 | 6.2 | B | 0.2 | B |
| Example 13 | 205 | 6.0 | 6.2 | 5.9 | 6.0 | B | 0.2 | B |
| Example 14 | 205 | 3.0 | 3.4 | 3.7 | 3.4 | C | 0.4 | C |
| Example 15 | 95 | 3.1 | 2.8 | 3.0 | 3.0 | C | 0.2 | B |
| Example 16 | 305 | 9.1 | 9.5 | 9.3 | 9.3 | A | 0.2 | B |
| Example 17 | 220 | 11.0 | 10.9 | 11.1 | 11.0 | A | 0.1 | A |
| Example 18 | 220 | 10.5 | 10.4 | 10.6 | 10.5 | A | 0.1 | A |
| Example 19 | 220 | 9.0 | 8.9 | 9.1 | 9.0 | A | 0.1 | A |
| Comparative | 190 | 2.0 | 3.6 | 3.0 | 2.9 | D | 0.8 | D |
| Example 1 | | | | | | | | |
| Comparative | 190 | 1.0 | 3.9 | 3.2 | 2.7 | D | 1.5 | D |
| Example 2 | | | | | | | | |
| Comparative | 190 | 9.0 | 2.0 | 6.0 | 5.7 | C | 3.5 | D |
| Example 3 | | | | | | | | |
| Comparative | 40 | Not measurable | | | — | D | — | D |
| Example 4 | | | | | | | | |
| Comparative | 330 | Not measurable | | | — | D | — | D |
| Example 5 | | | | | | | | |

Embodiments of the present disclosure are, for example, as follows.

1. A powder material for three-dimensional modeling includes a base material and a resin covering the base material, wherein the covering factor by the resin is 15 percent or more and the aspect ratio calculated according to the following relation 1 of the powder material is 0.90 or greater,

Aspect ratio (average value)=X1×Y1/100+X2×Y2/100+ . . . +Xn×Yn/100, Relation 1.

In the Relation 1, Y1+Y2+ . . . +Yn=100 (percent), Xn represents the aspect ratio (minor axis/major axis), Yn represents an existence ratio (percent) of a particle having an aspect ratio of Xn, and n is 15,000 or greater.

2. The powder material according to 1 mentioned above, wherein the covering factor by the resin is 50 percent or more.

3. The powder material according to 1 or 2 mentioned above, wherein the powder material has a volume average particle diameter of from 2 micrometer to 100 micrometer.

4. The powder material according to any one of 1 to 3 mentioned above, wherein the powder material has a ratio (D90/D10) of a volume-basis cumulative 90 percent diameter (D90) to a volume-basis cumulative 10 percent diameter (D10) of 3.0 or less as measured by a laser scattering particle size distribution measurement method.

5. The powder material according to any one of 1 to 4 mentioned above, wherein the amount of the resin attached to the powder material is 0.5 percent by mass of greater.

6. The powder material according to any one of 1 to 5 mentioned above, wherein the resin includes a water-soluble resin.

7. The powder material according to 6 mentioned above, wherein the water-soluble resin includes a modified polyvinyl alcohol.

8. The powder material according to any one of 1 to 7 mentioned above, wherein the base particle is insoluble in water.

9. The powder material of any one of 1 to 8 mentioned above, wherein the base particle includes either or both of a metal and ceramic.

10. A material set for three-dimensional modeling includes the powder material of any one of 1 to 9 mentioned above for three-dimensional modeling and a liquid material for three-dimensional modeling, the liquid material including a solvent configured to dissolve the resin.

11. The material set according to 10, wherein the liquid material includes either or both of water and a water-soluble solvent.

12. The material set according to 10 or 11, wherein the liquid material includes a cross-linking agent.

13. The material set according to 12, wherein the cross-linking agent includes a compound including a metal.

14. A device for manufacturing a 3D object includes the powder material set of any one of 10 to 13 mentioned above, a powder material layer forming device to form a layer of the powder material for 3D modeling, and a liquid material applying device to apply the liquid material.

15. The device according to 14 mentioned above, wherein the liquid material applying device takes an inkjet method.

16. A method of manufacturing a three-dimensional object includes forming a layer of the powder material of any one of 1 to 9 for three-dimensional modeling and applying a liquid material to the layer.

17. The method according to 16 mentioned above, wherein the applying is conducted by an inkjet method.

18. The method according to 16 or 17 mentioned above, further includes sintering the three-dimensional object.

19. A sintered compact manufactured by sintering a three-dimensional object modeled by using the material set of any one of 10 to 13 mentioned above.

20. A three-dimensional object manufactured by using the powder material of any one of 1 to 9 mentioned above, wherein the three-dimensional object having an average bend stress of 3.0 MPa or greater and a standard deviation of 0.5 or less.

According to the present disclosure, a powder material for 3D modeling is provided by which a three-dimensional object having a uniform strength can be manufactured while reducing variation of the strength of the three-dimensional object.

Having now fully described embodiments of the present invention, it will be apparent to one of ordinary skill in the art that many changes and modifications can be made thereto without departing from the spirit and scope of embodiments of the invention as set forth herein.

What is claimed is:

1. A powder material for three-dimensional modeling comprising:
a base material; and
a resin covering the base material,
wherein a covering factor by the resin is 15 percent by mass or more and
wherein an aspect ratio of the powder material is 0.90 or greater as calculated according to the following relation 1,
Aspect ratio (average)=X1×Y1/100+X2×Y2/100+ . . . +Xn×Yn/100, Relation 1
where Y1+Y2+ . . . +Yn=100 (percent), Xn represents the aspect ratio (minor axis/major axis), Yn represents an existence ratio (percent) of a particle having an aspect ratio of Xn, and n is 15,000 or greater.

2. The powder material according to claim 1, wherein the covering factor by the resin is 50 percent or more.

3. The powder material according to claim 1, wherein the powder material has a volume average particle diameter of from 2 micrometer to 100 micrometer.

4. The powder material according to claim 1, wherein the powder material has a ratio (D₉₀/D₁₀) of a volume-basis cumulative 90 percent diameter (D₉₀) to a volume-basis cumulative 10 percent diameter (D₁₀) of 3.0 or less as measured by a laser scattering particle size distribution measurement method.

5. The powder material according to claim 1, wherein an amount of the resin attached to the powder material is 0.5 percent by mass of greater.

6. The powder material according to claim 1, wherein the resin includes a water-soluble resin.

7. The powder material according to claim 6, wherein the water-soluble resin includes a modified polyvinyl alcohol.

8. The powder material according to claim 1, wherein the base material includes a material insoluble in water.

9. The powder material according to claim 1, wherein the base particle includes either or both of a metal and ceramic.

10. A material set for three-dimensional modeling comprising:
the powder material of claim 1 for three-dimensional modeling; and
a liquid material for three-dimensional modeling, the liquid material including a solvent configured to dissolve the resin.

11. The material set according to claim 10, wherein the liquid material includes either or both of water and a water-soluble solvent.

12. The material set according to claim 10, wherein the liquid material includes a cross-linking agent.

13. The material set according to claim 12, wherein the cross-linking agent includes a compound including a metal.

14. A device for manufacturing a three-dimensional object comprising:
a material set for three-dimensional modeling, the material set including the powder material of claim 1 for three-dimensional modeling; and
a liquid material for three-dimensional modeling, the liquid material including a solvent configured to dissolve the resin;
a powder layer forming device configured to form a layer of the powder material; and
a liquid material applying device to apply the liquid material to the layer of the powder material.

15. The device according to claim 14, wherein the liquid material applying device takes an inkjet method.

16. A method of manufacturing a three-dimensional object comprising:
forming a layer of the powder material of claim 1 for three-dimensional modeling; and,
applying a liquid material to the layer, the liquid material including a solvent configured to dissolve the resin.

17. The method according to claim 16, wherein the applying is conducted by an inkjet method.

18. The method according to claim 16, further comprising sintering the three-dimensional object.

19. A sintered compact manufactured by sintering a three-dimensional object modeled by using a material set including the powder material of claim 1 for three-dimensional modeling and a liquid material for three-dimensional modeling, the liquid material including a solvent configured to dissolve the resin.

20. A three-dimensional object manufactured by using the powder material of claim 1 for three-dimensional modeling, the three-dimensional object having an average bend stress of 3.0 MPa or greater and a standard deviation of 0.5 or less.
